(19) United States
(12) Patent Application Publication
(10) Pub. No.: US 2018/0066470 A1
(43) Pub. Date: Mar. 8, 2018

(54) VACUUM GLASS AND MANUFACTURING METHOD THEREFOR

(71) Applicant: Changhong DAI, Qingdao (CN)

(72) Inventor: Changhong DAI, Qingdao (CN)

(21) Appl. No.: 15/527,341

(22) PCT Filed: Nov. 18, 2015
(86) PCT No.: PCT/CN2015/094953

§ 371 Date: Jun. 19, 2017

(30) Foreign Application Priority Data
Nov. 19, 2014 (CN) 201410661219.6
Nov. 19, 2014 (CN) 201410661220.9
Nov. 19, 2014 (CN) 201410661221.3
Nov. 19, 2014 (CN) 201410661222.8
Nov. 19, 2014 (CN) 201410661223.2
Nov. 19, 2014 (CN) 201410661267.5
Nov. 19, 2014 (CN) 201410661351.7
Nov. 19, 2014 (CN) 201410661352.1
Nov. 19, 2014 (CN) 201410661385.6
Nov. 19, 2014 (CN) 201410661390.7
Nov. 19, 2014 (CN) 201410661391.1

(51) Int. Cl. E06B 3/663; C03C 27/10; C03C 27/08; C03B 23/20; C03B 27/00; E06B 3/673; E06B 3/677

(52) U.S. Cl. CPC E06B 3/66357; C03C 27/10; C03C 27/08; C03B 23/20; E06B 2003/6638; E06B 3/66347; E06B 3/67334; E06B 3/6775; C03B 27/00

(57) ABSTRACT

Vacuum glass includes a piece of upper glass, a piece of lower glass, and a closed vacuum layer sandwiched between the upper class and the lower glass, the peripheries of the upper glass and the lower glass are in seal connection using two or more layers of sealing material, the upper glass and the lower glass are convex glass or flat glass, convex surfaces of the convex glass face outward, and supports are disposed between two pieces of flat glass. The manufacturing method of the vacuum glass is simple, the prepared vacuum glass and tempered vacuum glass solve the defects in the prior art, can ensure the airtightness and service life of the vacuum glass, and are suitable for mechanization, automation, and mass production.

### BACKGROUND OF THE INVENTION

### Field of the Invention

The present invention relates to the deep processing technology of glass, and more particularly to vacuum glass and method for manufacturing the same.

### Description of the Related Art

Conventionally, the periphery of vacuum glass is sealed using glass solders, metal solders or organic adhesives, but the sealing modes have the following defects: when the glass solders are employed for edge sealing, the soldering temperature is high, which increases the difficulty to produce fully tempered vacuum glass, and even worse, the vacuum glass tends to release gas when being melted under vacuum, which not only causes the glass solder to produce a lot of bubbles, but also alters the properties of the glass solder, thus adversely affecting the bonding strength and airtightness, and increasing the difficulty to produce vacuum glass having long service life and high quality. When the metal solders are employed for edge sealing, because the melted metal solders tend to volatilize under vacuum, the volatile metal gaseous molecules deposit on the surface of the glass, or react with the air residual in the vacuum to yield a compound depositing on the surface of the glass, something like forming a vacuum coating, which not only affects the appearance of the vacuum glass, but also affects the light transmission of the vacuum glass, as a result, a satisfactory vacuum glass with good light transmission cannot be acquired; consequently, although the metal solders can reduce the sealing temperature thus producing tempered vacuum glass, the flexible edge sealing can effectively reduce the stress thus reducing the breakage rate of the vacuum glass, the lead-free sealing can eliminate the heavy metal pollution, vacuum glass whose edges are sealed with metal has not been found so far. The vacuum glass whose edges are sealed with organic adhesives is not provided with an airextraction process under high temperatures, and the organic adhesives have poor airtightness, the vacuum degree is difficult to hold, so the formed glass is considered as false vacuum glass. In conclusion, such three materials as glass solders, metal solders, and organic adhesives are not suitable for the direct sealing of vacuum glass alone under vacuum condition.

### SUMMARY OF THE INVENTION

In view of the above-described problems of existing vacuum glass, the present disclosure of the invention provides vacuum glass (tempered vacuum glass) and a preparation method thereof. The vacuum layer of the vacuum glass is sealed by two or more layers of sealing material, and the preparation method thereof is simple. The produced vacuum glass solves the defects in the prior art, has good airtightness, long service life, intensified strength, and good thermal and sound insulation properties.

To achieve the above objective, one embodiment of the present disclosure provides vacuum glass, comprising a piece of upper glass, a piece of lower glass, and a closed vacuum layer sandwiched between the upper class and the lower glass, peripheries of the upper glass and the lower glass are in seal connection using two or more layers of sealing material, the upper glass and the lower glass are convex glass or flat glass, convex surfaces of the convex glass face outward, and supports are disposed between two pieces of flat glass.

Preferably, the adhesive material is adhesives, solders, elastomers, flexible material, etc., more preferably, the sealing material is two or three different kinds of sealing materials selected from glass solders, metal solders, and adhesives, or two or three sealing materials of the same kind, including two kinds of simultaneously used glass solders, metal solders, and high temperature adhesives.

Preferably, the peripheries of the upper glass and/or the lower glass are provided with at least an edge-sealing groove, which can prevent the loss of the sealing material, increase the sealing area, and strengthen the sealing effect.

Preferably, the sealing material is coated on one or two sides of the edge-sealing groove, or coated on a place corresponding to the edge-sealing groove, or placed in the edge-sealing groove.

Preferably, a periphery of at least one glass of the upper glass and the lower glass is provided with an edge-sealing frame, and the edge-sealing frame is integrated with the upper glass and/or the lower glass. The edge-sealing frames on the upper and lower glass are embedded with each other thus changing the plane seal of the edges of the glass into a mazy curved seal, and the seal connection of the upper glass and the lower glass is achieved through the embedment of the edge-sealing frame and the edge-sealing groove.

Preferably, the sealing material is coated on the edge-sealing frame, or coated between adjacent edge-sealing frames, or coated on a place corresponding to the edge-sealing frame.

Preferably, a periphery of at least one glass of the upper glass and the lower glass is provided with an edge-sealing frame, and a periphery of at least one glass is provided with an edge-sealing groove. The edge-sealing frames on the upper and lower glass are coordinated with each other thus changing the plane seal of the edges of the glass into a mazy curved seal, and the seal connection of the upper glass and the lower glass is achieved through the embedment of the edge-sealing frame and the edge-sealing groove.

Preferably, the sealing material is coated on one or two sides of the edge-sealing groove, or coated on a place corresponding to the edge-sealing groove, or placed in the edge-sealing groove.

Preferably, the sealing material is coated on the edge-sealing frame, or coated between adjacent edge-sealing frames, or coated on a place corresponding to the edge-sealing frame.

Preferably, the sealing material is coated on the edge-sealing frame, or coated between adjacent edge-sealing frames, or coated on a place corresponding to the edge-sealing frame; the sealing material is coated on one or two sides of the edge-sealing groove, or coated on a place corresponding to the edge-sealing groove, or placed in the edge-sealing groove.

Preferably, the sealing material is glass solders or adhesives, and metal solders; the first and/or third layers of the sealing material are glass solders or adhesives, and the second layer of the sealing material is metal solders; the glass solders have low softening point and high viscosity, and the first sealing layer is in the innermost.

Preferably, the sealing material is glass solders, adhesives, or metal solders; the first layer of the sealing material is adhesives or glass solders, and the second layer of the sealing material is glass solders, adhesives, or metal solders; if both the two layers of the sealing material employ glass solders, the glass solders should comprise two different kinds of glass solder having different properties, for example, the first layer of the sealing material is softened but not melted for high temperature sealing, while the second layer of the sealing material is softened and melted for high temperature sealing.

Preferably, the sealing material comprises glass solders and adhesives; the first and/or third layers of the sealing material is adhesives or glass solders, and the second layer of the sealing material is glass solders; if both the two layers of the sealing material employ glass solders, the glass solders should comprise two different kinds of glass solder having different properties, for example, the first layer of the sealing material is softened but not melted for high temperature sealing, while the second layer of the sealing material is softened and melted for high temperature sealing.

Preferably, the supports are made of low temperature glass or high polymers.

Preferably, the supports are printed on the upper glass or the lower glass, and are dotted or cylindrical in shape.

Preferably, the supports are printed on both the upper glass and the lower glass, and are strip or linear in shape, and when the upper glass and the lower glass are merged, the supports on the upper and lower glass can alternatively support the glass.

Preferably, tops of the supports are mechanically processed to be flat or arc-shaped, and the tops of the flat supports are in the same plane.

Preferably, the upper and/or lower glass is transparent and/or colorless glass.

Preferably, the upper and/or lower glass is opaque and/or color glass.

In another aspect, the present disclosure provides a method for manufacturing the vacuum glass, the method comprising the following steps:

1) cutting and acquiring two pieces of flat glass having dimensions corresponding to a desired shape and size of the vacuum glass, and grinding, chamfering, washing, and drying the two pieces of flat glass;

2) when manufacturing convex vacuum glass, performing hot bending on the two pieces of flat glass to form convex surfaces; when manufacturing flat vacuum glass, disposing the supports on at least one piece of flat glass, if disposing the supports on the two pieces of flat glass, staggering the supports on the two pieces of glass so as to ensure the alternate support of merged upper glass and lower glass; and when preparing tempered vacuum glass, tempering the two pieces of glass, respectively;

3) uniformly coating two or more layers of sealing material on peripheries of sealing surfaces of the lower glass or the two pieces of glass, the sealing material comprising a plurality of uniformly-distributed air extraction holes which can accelerate the air extraction rate, merging the two pieces of glass and putting into a vacuum furnace; according to the properties of the sealing material and the glass and the requirements of manufacturing process, preheating or pre-evacuating the glass prior to or after the merging; and

4) vacuumizing the vacuum furnace to less than 0.1 Pa and heating the vacuum furnace to above a softening temperature of at least one sealing material, sealing the vacuum layer using the at least one sealing material by gravity or external pressure; continuing heating the vacuum furnace in vacuum or in air to reach a melting temperature of a second or third sealing material, holding the temperature, stopping heating, naturally cooling the furnace, whereby sealing the two pieces of glass by the sealing material, opening a furnace door of the vacuum furnace to obtain the vacuum glass.

Preferably, in 3), the sealing material is two or three different kinds of sealing materials selected from glass solders, metal solders, and adhesives, or two different glass solders, or a mixture of the same kind of materials (e.g., two glass solders having different properties), or a mixture of different kinds of materials.

Preferably, in 4), following the seal achieved by at least one sealing material, removing the vacuum, heating the vacuum furnace in air to reach a melting temperature of a second or third sealing material, holding the temperature, stopping heating, naturally cooling the furnace, whereby sealing the two pieces of glass by the sealing material, opening a furnace door of the vacuum furnace to obtain the vacuum glass.

Preferably, in 2), the supports are made of low temperature glass or high polymers; the supports printed on the upper glass or the lower glass are dotted or cylindrical in shape, and the supports printed on both the upper glass and the lower glass are strip or linear in shape.

Preferably, in 2), the supports are printed prior to or after the tempering of the glass; when the supports are printed prior to the tempering of the glass, after being tempered, the supports are mechanically ground to remove and flatten tips of the supports, followed by rounding of top edges of the supports.

Preferably, in 1), prior to grinding, chamfering, washing, and drying, the method further comprises disposing one or more edge-sealing grooves on at least the upper or lower glass.

Preferably, the metal solders can fill up the space between the two layers of adhesives or connect the upper and lower glass, optionally, the metal solders may not fill up the space between the two layers of adhesives or not connect the upper and lower glass, which function as a coating material.

Preferably, in 2), the method further comprises disposing one or more edge-sealing frames on peripheries of sealing surfaces of at least one glass of the upper glass and/or the lower glass; when manufacturing convex vacuum glass, performing hot bending on the two pieces of flat glass to form convex surfaces; when manufacturing flat vacuum glass, disposing the supports on at least one piece of flat glass, if disposing the supports on the two pieces of flat glass, staggering the supports on the two pieces of glass so as to ensure the alternate support of merged upper glass and lower glass; and when preparing tempered vacuum glass, tempering the two pieces of glass, respectively.

Preferably, in 3), the method comprises coating two or more two or more layers of sealing material on peripheries of sealing surfaces of the lower glass or the two pieces of glass, and a second sealing layer is a metal sealing layer; if the upper glass and/or the lower glass comprises the edge-sealing frame, the sealing material is coated on the edge-sealing frame, or coated between adjacent edge-sealing frames, or coated on a place corresponding to the edge-sealing frame; if the upper glass and/or the lower glass comprises the edge-sealing groove, the sealing material is coated on one or two sides of the edge-sealing groove, or coated on a place corresponding to the edge-sealing groove, or placed in the edge-sealing groove; the sealing material comprises a plurality of uniformly-distributed air extraction holes, the two pieces of glass are merged and put into a vacuum furnace which is a continuous vacuum furnace or a batch-type vacuum furnace; according to the properties of the sealing material and the glass and the requirements of manufacturing process, performing pretreatment comprising washing, heating and evacuating the glass prior to or after the merging.

Advantages of the vacuum glass and the manufacturing method thereof are summarized as follows:

The vacuum glass of the present disclosure employs two or more sealing materials to form two or more sealing layers to seal the upper and lower glass. The vacuum layer of the vacuum glass is compositely sealed using different sealing materials which present different properties under different stages and different temperatures in the sealing process of the vacuum glass. The present disclosure makes full use of the advantages of different sealing materials, solves the conventional defects through the mutual coordination of the sealing materials under different temperatures, and solves the technical problems facing one sealing material and one layer of sealing. When the first and third layers of sealing materials for sealing the vacuum layer of the vacuum glass in the present disclosure preferably employ glass solders or high polymers, and the second sealing layer preferably employ metal solders, the main role of the first sealing layer is to seal the vacuum layer before the metal solders are melted, thus preventing the gaseous molecules resulting from the melting of the metal solders from entering the vacuum layer and depositing on the glass surface, so it is not necessary to pay much attention on the sealing temperature, mechanical properties, water resistant properties, ageing resistant properties, and the duration of the airtightness of the first layer of sealing material; so, there is a large range of choice for the first sealing material, which is favorable to reducing the production costs. The second sealing material made of metal solders is heated and melted after the vacuum glass is sealed by the first and third sealing materials, which can prevent the metal vapor from depositing on the glass surface, prevent the volatilization of the metal solders in large scale, thus saving the materials and reducing the costs, and the produced vacuum glass sealed by metal solders has good light transmission. Preferably, the vacuum glass of the present disclosure employs two or three sealing layers, if glass solders are applied in the first or third sealing layer, the glass solders can be controlled to soften but not melt, which not only reduces the sealing temperature, but also solves the problems that the glass solders tend to bubble, carbonize, exhibit low adhesion properties, large brittleness, tenacity-free, poor long-term airtightness, high sealing temperature thus causing the tempered glass to anneal and resulting in the failure to produce vacuum glass and tempered vacuum glass; in addition, the problems of the deposition of metal solders on the glass surface, the large consumption of the metal solders, poor long-term airtightness of the polymers, and short service life of the vacuum glass are also solved. When the metal solders are used as the first sealing layer, the deposition of the metal solders on the glass surface can achieve the vacuum plating effect, or the metal solders function as an air absorber to absorb the air in the vacuum layer. The coordination of various sealing materials greatly improves the sealing properties of the vacuum layer between the upper glass and the lower glass and significantly prolongs the service life of the vacuum glass. Through direct sealing of the edges of the glass under vacuum, the preparation and sealing of the air extraction holes are omitted, so that the vacuum glass and tempered vacuum glass can be one-step manufacture in large quantity, which promotes the industrial production of the vacuum glass and tempered vacuum glass, greatly improves the production efficiency and acceptability rate of the vacuum glass, and reduces the production costs of the vacuum glass. In addition, compared existing vacuum glass on the market, the hard and brittle connection of the upper glass and the lower glass is transformed into a soft and ductile connection of the present disclosure, which reduces the stress produced in the sealing process, reduces the stress formed by the temperature difference between inside and outside of the vacuum glass, thus greatly reducing the explosive rate of the vacuum glass.

### BRIEF DESCRIPTION OF THE DRAWINGS

FIG. 1 is a schematic diagram of vacuum glass in accordance with Example 1 of the invention;

FIG. 2 is a schematic diagram of vacuum glass in accordance with Example 2 of the invention;

FIG. 3 is a schematic diagram of vacuum glass in accordance with Example 3 of the invention;

FIG. 4 is a schematic diagram of vacuum glass in accordance with Example 4 of the invention;

FIG. 5 is a schematic diagram of vacuum glass in accordance with Example 5 of the invention;

FIG. 6 is a schematic diagram of vacuum glass in accordance with Example 6 of the invention;

FIG. 7 is a schematic diagram of vacuum glass in accordance with Example 7 of the invention;

FIG. 8 is a schematic diagram of vacuum glass in accordance with Example 8 of the invention;

FIG. 9 is a schematic diagram of vacuum glass in accordance with Example 9 of the invention;

FIG. 10 is a schematic diagram of vacuum glass in accordance with Example 10 of the invention;

FIG. 11 is a schematic diagram of vacuum glass in accordance with Example 11 of the invention;

FIG. 12 is a schematic diagram of vacuum glass in accordance with Example 12 of the invention;

FIG. 13 is a schematic diagram of vacuum glass in accordance with Example 13 of the invention;

FIG. 14 is a schematic diagram of vacuum glass in accordance with Example 14 of the invention;

FIG. 15 is a schematic diagram of vacuum glass in accordance with Example 15 of the invention;

FIG. 16 is a schematic diagram of vacuum glass in accordance with Example 16 of the invention;

FIG. 17 is a schematic diagram of vacuum glass in accordance with Example 18 of the invention;

FIG. 18 is a schematic diagram of vacuum glass in accordance with Example 19 of the invention;

FIG. 19 is a schematic diagram of vacuum glass in accordance with Example 20 of the invention;

FIG. 20 is a schematic diagram of vacuum glass in accordance with Example 24 of the invention;

FIG. 21 is a schematic diagram of vacuum glass in accordance with Example 25 of the invention;

FIG. 22 is a schematic diagram of vacuum glass in accordance with Example 26 of the invention;

FIG. 23 is a schematic diagram of vacuum glass in accordance with Example 27 of the invention;

FIG. 24 is a schematic diagram of vacuum glass in accordance with Example 28 of the invention;

FIG. 25 is a schematic diagram of vacuum glass in accordance with Example 29 of the invention; and

FIG. 26 is a schematic diagram of vacuum glass in accordance with Example 30 of the invention.

Legends: 1. Upper glass; 2. Lower glass; 3. First sealing layer; 4. Second sealing layer; 5. Third sealing layer; 6. Support; 7. Groove; 8. Frame; 9. Middle glass.

### DETAILED DESCRIPTION OF THE EMBODIMENTS

For further illustrating the invention, experiments detailing vacuum glass and manufacturing method thereof are described below. It should be noted that the following examples are intended to describe and not to limit the invention.

The present disclosure provides vacuum glass, comprising a piece of upper glass, a piece of lower glass, and a closed vacuum layer sandwiched between the upper class and the lower glass; peripheries of the upper glass and the lower glass are in seal connection using two or more layers of sealing material, the upper glass and the lower glass are convex glass or flat glass, convex surfaces of the convex glass face outward, and supports are disposed between two pieces of flat glass.

Preferably, the adhesive material is adhesives, solders, elastomers, flexible material, etc., more preferably, the sealing material is two or three different kinds of sealing materials selected from glass solders, metal solders, and adhesives, or two or three sealing materials of the same kind; two kinds of glass solders, metal solders, and high temperature adhesives are simultaneously used to seal the vacuum layer of the vacuum glass using two or more sealing layers.

The first sealing layer is innermost, that is, the first sealing layer is closest to the vacuum layer.

The two or more layers of sealing material are two or three different kinds of sealing materials selected from glass solders, metal solders, and adhesives, or two or three sealing materials of the same kind; at least one sealing layer is metal solders, because metal solders have better airtightness, flexibility, tenacity, and wide soldering temperature range, they can ensure the airtightness of vacuum glass, reduce the stress of glass, and prolong the service life, thus facilitating the production of tempered vacuum glass.

Preferably, with regard to the two or more layers of sealing material, glass solders or adhesives are used as the first sealing layer of the vacuum layer, metal solders are used as the second sealing layer of the vacuum layer; under the protection of the first sealing layer, the metal solders can be prevented from volatilizing and depositing on the glass surface facing the vacuum layer, thus producing vacuum glass having high light transmission.

Preferably, the sealing material comprises glass solders and adhesives, the first or third sealing material of the vacuum layer employs adhesives or glass solders, and the second sealing material is glass solders; if both the two sealing layers adopt glass solders, the selected two glass solders should have different characteristics, for example, the first layer of the sealing material is softened but not melted for high temperature sealing, while the second layer of the sealing material is softened and melted for high temperature sealing.

Preferably, if glass solders are used as the first or third layer of sealing material, low melting point glass solders should be selected, more preferably, glass solders having low softening point and high viscosity are selected, with a softening temperature of 150-380□, particularly 200-320□; after being softened, the glass solders have high viscosity, and do not flow at the temperature of 300-460□, and do not flow at the temperature of 340-420□.

Preferably, if glass solders are used as the second or third layer of sealing material, low melting point glass solders should be selected, more preferably, glass solders having low softening point and low soldering temperature are selected, with a softening temperature of 150-380□, particularly 200-320□, a soldering temperature of 320-460□, particularly 340-420□.

Preferably, the metal solders comprise metal and alloy solders, with a soldering temperature of 150-400□, particularly 280-380□, such as tin and tin alloy, magnesium and magnesium alloy, zinc and zinc alloy, or the like.

Preferably, the adhesives are high temperature resistant inorganic or organic adhesives or composite adhesives, the highest temperature can be 150-400□, such as high temperature resistant organic adhesives (polyimide, polybenzimidazole, polybenzothiazole, polyarylsulfone, polyphenylene sulfide, organosilicon, modified epoxy resin, phenolic resin and polyarylether, etc.), high temperature resistant coatings, high temperature resistant inorganic adhesives, organic or inorganic high temperature resistant composite adhesives, or the like.

Preferably, the glass solders have low softening point and high viscosity, and when the metal solders are melted, the glass solders do not flow.

Preferably, with regard to two or more layers of sealing material, when the metal solders are used as the second layer of sealing material, preferably, the melting point of the metal solders is higher than the softening point of the first layer of sealing material, that is to say, only when the first layer of sealing material is melted, can the metal solders start to melt.

Preferably, the first sealing layer is a permanent or temporary, i.e., only after the metal solders are melted, the first sealing layer seals the vacuum layer to prevent the gaseous molecules of the metal solders from entering the vacuum layer and depositing on the glass surface thus affecting the light transmission of the glass, which means, the metal solders play a major role in sealing the vacuum glass, and other sealing materials are auxiliary for sealing the vacuum glass.

Preferably, with regard to two or more layers of sealing material, three sealing layers are more preferable, specifically, the first sealing layer is glass solders or adhesives, the second sealing layer is metal solders, and the third sealing layer is glass solders or adhesives.

Preferably, with regard to two or more layers of sealing material, when the sealing material is adhesives and glass solders, the first sealing layer is adhesives or glass solders or metal solders, the second sealing layer is glass solders, or the first and third sealing layers are adhesives or glass solders, the second sealing layer is glass solders; when two sealing layers are employed, preferably, the first sealing process is performed under vacuum, followed by removing the vacuum, and perform the second sealing in the air.

Preferably, the two or more layers of sealing material are coated on the glass surface manually or mechanically, particularly mechanically, such as screen or stencil printing, printer or dispenser, gumming machine coating.

Preferably, the two or more sealing layers are formed by pressing, that is, in the presence of extra pressure, which comprises atmospheric pressure, gravity, elastic force and mechanical force such as rolling pressure.

Preferably, the metal comprises alloy, particularly active metals having low melting point, high volatility, strong reducibility, and such as tin and tin alloy, magnesium and magnesium alloy, zinc and zinc alloy, or the like.

As an improvement, the peripheries of the upper glass and/or the lower glass are provided with at least an edge-sealing groove.

As an improvement, the periphery of the sealing surface of the upper glass is provided with the edge-sealing groove, the edge-sealing groove is corresponding to the first or second sealing material of the lower glass, particularly, corresponding to the second sealing material.

As an improvement, the peripheries of the sealing surfaces of the upper and lower glass are provided with the edge-sealing grooves, respectively, the upper edge-sealing groove is corresponding to the lower edge-sealing groove, particularly, corresponding to the second sealing material.

As an improvement, the periphery of the sealing surface of the upper glass is provided with two edge-sealing grooves, the two edge-sealing grooves are corresponding to the first and the third sealing materials of the lower glass, respectively, the second layer of sealing material is sandwiched between the two edge-sealing grooves; when a plurality of edge-sealing grooves are disposed, the rest can be done in the same manner.

As an improvement, the edge-sealing groove is a continuous groove formed on the periphery of the welding surface of the glass by mechanical processing or laser processing, preferably, mechanical processing, such as mechanical grinding, mechanical carving, etc.

As an improvement, the depth of the edge-sealing groove is 0.1-2 mm, preferably, 0.3-1 mm, the width thereof is 0.3-10 mm, preferably, 1.5-4 mm.

As an improvement, the cross section of the edge-sealing groove is arbitrary in shape, preferably, arc or rectangular.

As an improvement, a periphery of at least one glass of the upper glass and the lower glass is provided with an edge-sealing frame, and the edge-sealing frame is integrated with the upper glass and/or the lower glass, which changes the plane seal of the edges of the glass into a mazy curved seal, and the seal connection of the upper glass and the lower glass is achieved through the edge-sealing frame.

As an improvement, the periphery of the sealing surface of the upper glass is provided with an edge-sealing frame, which is disposed between two layers of sealing material.

As an improvement, the periphery of the sealing surface of the upper or lower glass is provided with two edge-sealing frames, which are corresponding to two layers of sealing material, respectively.

As an improvement, the periphery of the sealing surface of the upper glass is provided with an edge-sealing frame, the periphery of the sealing surface of the lower glass is provided with two edge-sealing frames, and the edge-sealing frame on the upper glass is embedded between the two edge-sealing frames on the lower glass; the sealing material can be coated on the sealing frame of the lower glass and/or a place corresponding to the upper glass.

As an improvement, a periphery of at least one glass of the upper glass and the lower glass is provided with an edge-sealing frame, and a periphery of at least one glass is provided with an edge-sealing groove. The edge-sealing frames on the upper and lower glass are coordinated with each other thus changing the plane seal of the edges of the glass into a mazy curved seal, and the seal connection of the upper glass and the lower glass is achieved through the embedment of the edge-sealing frame and the edge-sealing groove.

As an improvement, the periphery of the sealing surface of the upper glass is provided with an edge-sealing frame, and the periphery of the sealing surface of the lower glass is provided with an edge-sealing groove, the edge-sealing frame is corresponding to the edge-sealing groove, and disposed between two layers of sealing material.

As an improvement, the periphery of the sealing surface of the upper glass is provided with at least one edge-sealing frame, and the periphery of the sealing surface of the lower glass is provided with at least two edge-sealing frames between which an edge-sealing is disposed, the edge-sealing frame on the upper glass is embedded in the edge-sealing groove between the edge-sealing frames on the lower glass; the sealing material can be coated on the sealing frame of the lower glass and/or a place corresponding to the upper glass.

As an improvement, the periphery of the sealing surface of the upper or lower glass is provided with two edge-sealing frames, and the periphery of the sealing surface of the lower or upper glass is provided with two edge-sealing grooves, the edge-sealing frames are corresponding to the edge-sealing grooves, particularly corresponding to the first and third layer of sealing material, and the second layer of sealing material is disposed between two edge-sealing frames and/or edge-sealing grooves.

As an improvement, the edge-sealing frames can be made by pressing, etching, or coating, and mechanical coating is preferable, or be made of metal wires, temperature glass powders or adhesives which are sintered with glass under high temperature.

As an improvement, the coating is achieved by printing or printers or dispensers; low temperature glass powders (pastes) or adhesives or metal powders (pastes) are placed on the glass surface to form continuous ribs bulging on the glass surface, and the ribs are integrated with the glass after being sintered and cured under high temperature; when the edge-sealing frames are formed by coating, the coating operation is carried out only one time, or several times.

As an improvement, the edge-sealing frame can be prepared prior to or after the tempering of the glass; if the edge-sealing frame is prepared prior to the tempering of the glass, preferably, low temperature glass powders (such as ink for tempered glass) is selected as raw material, which is sintered with glass under high temperature in a toughening furnace; if the edge-sealing frame is prepared after the tempering of the glass, preferably, low temperature glass solders (low softening point and high viscosity) or high temperature resistant polymers (resin) are selected as raw material, at this point, the edge-sealing frame can be used as the first and/or third sealing material.

As an improvement, the height of the edge-sealing groove is 0.1-3 mm, preferably, 0.3-1.5 mm, the width thereof is 0.2-5 mm, preferably, 1-2 mm

As an improvement, the vacuum glass further comprises a piece of flat glass which is sandwiched between the upper glass and the lower glass, and two closed vacuum layer are formed by the upper glass, the lower glass and the flat glass.

As an improvement, the vacuum glass further comprises a plurality of flat glass, thus a plurality of closed vacuum layers are formed.

As an improvement, the raw material of the supports is low temperature glass, metal, ceramics, glass, or high temperature resistant polymers, preferably, low temperature glass or high polymers.

As an improvement, the minimum unit of the supports is dot matrix or grid of square or equilateral triangle, and the length of side is 30-300 mm, preferably, 50-100 mm. The supports are dotted, strip, linear or grid in shape; the strip supports have a length of 0.3-5.0 mm, preferably, 1.0-3.0 mm, a width of 0.1-2.0 mm, preferably, 0.2-1.0 mm, a height of 0.1-2.0 mm, preferably, 0.2-1.0 mm. The linear supports have a width of 0.1-2.0 mm, preferably, 0.2-1.0 mm, a height of 0.1-2.0 mm, preferably, 0.2-1.0 mm. The dotted supports have a diameter of 0.1-3.0 mm, preferably, 0.3-1.0 mm, a height of 0.1-1.0 mm, preferably, 0.2-0.6 mm.

As an improvement, when low temperature glass or high polymers are used to prepare the supports, preferably, low temperature glass powders or low temperature glass solders or high temperature resistant polymers (precursors or adhesives) are employed, and printed or stamped or dispensed; the sintering temperature of the low temperature glass solders is lower than that of the low temperature glass powders.

When the supports are printed on one piece of glass, the preferable shape is dotted or cylindrical; when the supports are simultaneously printed on the upper and lower glass, the preferable shape is strip or linear; when the upper glass and the lower glass are merged, the supports on the upper and lower glass can support the merged glass alternately.

As an improvement, tops of the supports are mechanically processed to be flat or arc-shaped, and the tops of the flat supports are in the same plane.

As an improvement, the upper and/or lower glass is transparent and/or colorless glass.

As an improvement, the upper and/or lower glass is opaque and/or color glass.

As an improvement, the sagitta of the convex upper and lower glass is preferably 0.1-200 mm, more preferably, 1-20 mm, when being used as the glass of doors and windows, the convex surface of the upper and lower glass should not protrude out of the frames of the doors and windows.

The sagitta of the convex upper and lower glass is the same; as needed, different sagitta can be designed according to the internal and external width of the frames of the doors and windows.

The sealing material is coated on the periphery of the sealing surfaces of at least one of the upper glass and lower glass or two pieces of glass, as well as the periphery of the sealing surface of the middle glass.

The sealing material contacts the upper glass, the lower glass and the middle glass directly or via a middle layer (such as metal paste layer), or contacts the edge-sealing frame, or contacts the edge-sealing groove; the metal solders performs the seal via a transition layer (such as silver paste layer)sintered using a toughening furnace or high temperature furnace.

In the vacuum layer, when the upper and lower glass are convex glass, if the plane size thereof is small or the sagittal thereof is large enough to resist the atmospheric pressure by the convex shape and strength of the glass, the supports can be omitted. When the convex shape and strength of the glass cannot resist the atmospheric pressure, a few indispensible supports should be disposed to resist the atmospheric pressure together with the glass. When the upper and lower glass are flat glass, the supports must be disposed in the vacuum layer.

When the supports are printed prior to the tempering of the glass, low temperature glass powders are preferable, and sintered, cured, and integrated with the glass under high temperature in the toughening furnace; when the supports are printed after the tempering of the glass, low temperature glass solders or high polymers are preferable, and sintered, cured, and integrated with the glass under high temperature in the vacuum furnace.

When the supports are printed prior to the tempering of the glass, preferably, after being tempered, the supports are mechanically ground to remove and flatten tips of the supports, thus eliminating the deformation of the tempered glass and increasing the supporting area; subsequently, the flattened top edges of the supports are rounded, so as to eliminate the stress, prevent the break of the supports or glass, and enhance the shock resistance of the vacuum glass.

The upper and lower glass may be common glass, ultra-clear glass, tempered glass, semi tempered glass, or low emissivity glass, wired glass, rolled glass, hot-melt glass, enamelled glass, or a combination of two or three of the aforesaid glass, preferably, ultra-clear glass, tempered glass, semi tempered glass, or low emissivity glass, or a combination of two or three of the aforesaid glass.

When the upper and lower glass are low emissivity glass, the film coating is followed by the tempering, or the film coating follows the tempering; to solve the problem of the smoothness and oxidation discoloration of the film of the tempered glass, preferably, the film coating follows the tempering, and a continuous tempering furnace is employed; preferably, the glass is ultra-clear glass, which can prevent the self-destruction of the glass.

The present disclosure also provides a method for manufacturing the vacuum glass, the method comprising the following steps:

1) cutting and acquiring two pieces of flat glass having dimensions corresponding to a desired shape and size of vacuum glass, and grinding, chamfering, washing, and drying the two pieces of flat glass;

2) when manufacturing convex vacuum glass, performing hot bending on the two pieces of flat glass to form convex surfaces; when manufacturing flat vacuum glass, disposing the supports on at least one piece of flat glass, if disposing the supports on the two pieces of flat glass, staggering the supports on the two pieces of glass so as to ensure the alternate support of merged upper glass and lower glass; and when preparing tempered vacuum glass, tempering the two pieces of glass, respectively;

3) uniformly coating two or more layers of sealing material on peripheries of sealing surfaces of the lower glass or the two pieces of glass, the sealing material comprising a plurality of uniformly-distributed air extraction holes which can accelerate the air extraction rate, merging the two pieces of glass and putting into a vacuum furnace; according to the properties of the sealing material and the glass and the requirements of manufacturing process, preheating or pre-evacuating the glass prior to or after the merging; and

4) vacuumizing the vacuum furnace to less than 0.1 Pa and heating the vacuum furnace to above a softening temperature of at least one sealing material, sealing the vacuum layer using the at least one sealing material by gravity or external pressure; continuing heating the vacuum furnace in vacuum or in air to reach a melting temperature of a second or third sealing material, holding the temperature, stopping heating, naturally cooling the furnace, whereby sealing the two pieces of glass by the sealing material, opening a furnace door of the vacuum furnace to obtain the vacuum glass.

The one-step forming of vacuum glass comprising two vacuum layers is summarized as follows:

Following the pretreatment, the periphery of the sealing surfaces of the upper, lower, and middle glass are uniformly coated with the sealing material; the sealing material comprises a plurality of slots or slits longitudinally running through the sealing material as air extraction holes; the three pieces of glass are merged and put into a vacuum sealing surface, then vacuumizing the vacuum furnace to less than 0.1 Pa and heating the vacuum furnace to above a softening temperature of at least one sealing material, sealing the vacuum layer using the at least one sealing material by gravity or external pressure; continuing heating the vacuum furnace to reach a melting temperature of a second or third sealing material, holding the temperature, stopping heating, naturally cooling the furnace, whereby sealing the two pieces of glass by the sealing material, opening a furnace door of the vacuum furnace to obtain the vacuum glass.

Preferably, in 4), following the seal achieved by at least one sealing material, removing the vacuum, heating the vacuum furnace in air to reach a melting temperature of a second or third sealing material, holding the temperature, stopping heating, naturally cooling the furnace, whereby sealing the two pieces of glass by the sealing material, opening a furnace door of the vacuum furnace to obtain the vacuum glass.

Preferably, in 2), the supports are made of low temperature glass or high polymers; the supports printed on the upper glass or the lower glass are dotted or cylindrical in shape, and the supports printed on both the upper glass and the lower glass are strip or linear in shape.

Preferably, the supports are printed prior to or after the tempering of the glass; when the supports are printed prior to the tempering of the glass, after being tempered, the supports are mechanically ground to remove and flatten tips of the supports, followed by rounding of top edges of the supports.

Preferably, in 1), prior to grinding, chamfering, washing, and drying, the method further comprises disposing one or more edge-sealing grooves on at least the upper or lower glass.

Preferably, in 2), the method further comprises disposing one or more edge-sealing frames on peripheries of sealing surfaces of at least one glass of the upper glass and/or the lower glass; when manufacturing convex vacuum glass, performing hot bending on the two pieces of flat glass to form convex surfaces; when manufacturing flat vacuum glass, disposing the supports on at least one piece of flat glass, if disposing the supports on the two pieces of flat glass, staggering the supports on the two pieces of glass so as to ensure the alternate support of merged upper glass and lower glass; and when preparing tempered vacuum glass, tempering the two pieces of glass, respectively.

Preferably, in 3), the method comprises coating two or more two or more layers of sealing material on peripheries of sealing surfaces of the lower glass or the two pieces of glass prepared in 2); if the upper glass and/or the lower glass comprises the edge-sealing frame or edge-sealing groove, the sealing material is coated on a place corresponding to the edge-sealing groove or edge-sealing frame; the sealing material comprises a plurality of uniformly-distributed air extraction holes, the two pieces of glass are merged and put into a vacuum furnace which is a continuous vacuum furnace or a batch-type vacuum furnace; according to the properties of the sealing material and the glass and the requirements of manufacturing process, performing pretreatment comprising washing, heating and evacuating the glass prior to or after the merging.

To reduce the construction cost and save the energy consumption, the vacuum furnace may comprise a basic heating system and local heating system; the basic heating system employs a resistance heating mode, such as electric heating wire, electric heating tube, electric heating plate, etc., to heat the vacuum furnace and the glass to a base temperature; thereafter, the periphery of the glass, that is, the sealing positions of the glass, is locally heated using resistance heating, infrared heating, laser heating, electromagnetic heating or microwave heating, so as to heat and melt the sealing material in a short time.

The temperature range of the basic heating is preferably 150-300□, and the temperature range of the local heating is preferably 280-450□.

To shorten the time for vacuumization and enhance the production efficiency, prior to merging, the upper and lower glass are washed using ultraviolet or plasma, so as to remove the gaseous molecules and water molecules adsorbed on the glass surface.

To shorten the heating time and enhance the production efficiency, prior to or after merging, the upper and lower glass arepreheated, so as to enhance the heating uniformity of the glass.

To shorten the time for vacuumization and enhance the heating uniformity of the glass, when the first and/or third sealing material take effects, the vacuum is removed, and the heating is performed in the air.

To shorten the time for vacuumization and enhance the vacuum degree of the vacuum layer, active metals, such as aluminum, magnesium, etc., can be placed in the vacuum layer.

To enhance and maintain the vacuum degree of the vacuum layer and prolong the service life of the vacuum glass, a gas absorbent can be placed in the vacuum layer, and the gas absorbent is evaporable or non-evaporable.

The vacuum furnace is a batch-type vacuum heating furnace or a continuous vacuum heating furnace, and a continuous vacuum heating furnace is preferable.

The merging of the upper glass and the lower glass can be achieved in or outside the vacuum furnace; when the vacuum furnace is a continuous vacuum heating furnace, the merging is made preferably in the furnace.

The present invention is further illustrated with specific embodiments.

### Example 1

As shown in FIG. 1, vacuum glass comprises composite sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, and grinding, chamfering, washing, and drying the two pieces of glass; secondly, disposing cylindrical supports 6 on the upper glass 1 or the lower glass 2 using tempered glass ink and a glue dispenser, putting the two pieces of glass into a tempered furnace where the supports are sintered on the glass; mechanically grinding the sintered supports 6 to flatten the tops thereof, and then rounding top edges of the supports 6 so as to eliminate the stress; uniformly coating one layer of low temperature glass solder and two layers of silicone adhesive on the periphery of one or two pieces of the glass using a coating machine, the first sealing material 3 and the third sealing material 5 are silicone adhesive, the second sealing material 4 is low temperature glass solder which is sandwiched between the two layers of silicone adhesive, the solder comprises a plurality of air extraction holes, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above 300□, extracting the air in the glass under high temperature, sealing the vacuum layer and the low temperature glass solder using the silicone adhesive by gravity or external pressure so as to prevent the gas release, bubbling or carbonization of the glass solder under vacuum; continuing heating the vacuum furnace to above a softening temperature of 350□ of the glass solder, the glass solder being softened, stopping heating, naturally cooling the furnace, whereby sealing the two pieces of glass by the silicone adhesive and the glass solder, opening a furnace door of the vacuum furnace to obtain the vacuum glass.

The inventive step of the present disclosure lies in that: in the drying and sintering process, the volume of the dotted supports contracts and varies, leading to nonuniform top height and the formation of the tips, so that the stress is concentrated, reducing the shock resistance of the tempered glass; in the present disclosure, the tips of the supports are mechanically ground and flattened, thus increasing the supporting area with the glass, and improving the shock resistance of the tempered glass.

The glass solder is sealed by the silicone adhesive, thus eliminating the effect of the vacuum on the glass solder.

The softened glass solder has good airtightness, thus solving the problem of poor airtightness of the silicone adhesive.

### Example 2

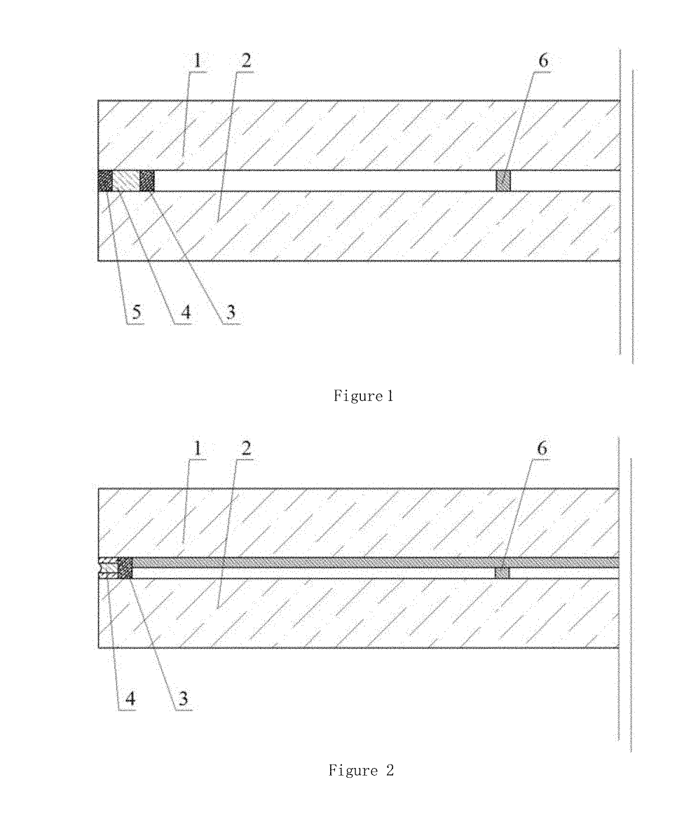

As shown in FIG. 2, a flat vacuum glass comprises two sealing layers and two pieces of tempered glass, one of which is a piece of low emissivity glass. The vacuum glass comprises a piece of upper glass 1, a piece of lower glass 2, and a closed vacuum layer sandwiched between the upper glass 1 and the lower glass 2. The first sealing layer 3 is polyimide adhesive, the second sealing layer 4 is a metal solder, the peripheries of the two pieces of glass are welded using the first sealing layer of polyimide adhesive and the second sealing layer of the metal solder, a vacuum layer is disposed between the two pieces of the glass. The vacuum glass is manufactured as follows: firstly, cutting and acquiring two pieces of flat glass having dimensions corresponding to a desired shape and size of vacuum glass, and grinding, chamfering, washing, and drying the two pieces of glass; secondly, coating silver paste on the welding surface of the metal solder of the two pieces of glass, putting the two pieces of glass into a tempered furnace where the coated silver slurry is also sintered on the glass; thirdly, disposing linear supports 6 on the two pieces of glassusing polyimide adhesives and a glue dispenser, the supports on the upper and lower glass are staggered after the two pieces of glass are merged; uniformly coating polyimide adhesive and tin alloy soldering paste on the periphery of one or two pieces of the glass using a coating machine, the solder comprises a plurality of air extraction holes, placing a gas absorbent in between the two pieces of the glass, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above a gelling temperature of 250□ of the polyimide, the gas absorbent being activated under high temperature and high vacuum, sealing the vacuum layer using the polyimide adhesive which is cured and softened by gravity or external pressure so as to prevent the gas release, bubbling or carbonization of the glass solder under vacuum; continuing heating the vacuum furnace to above a melting temperature of 280□ of the tin alloy, the tin alloy being softened, stopping heating, naturally cooling the furnace, whereby sealing the two pieces of glass by the tin alloy, opening a furnace door of the vacuum furnace to obtain the vacuum glass.

The inventive step of the present disclosure lies in that: the linear and ductile supports prepared by the polyimide adhesives enhance the shock resistance of the vacuum glass, and when the glass breaks, the supports can adhere to the glass fragments and prevent the falling of the glass, thus further enhancing the safety of the glass.

In this example, the peripheries of the two pieces of glass can be soldered using a first sealing layer 3 which is metal solders and a second sealing layer 4 which is low temperature glass solder.

### Example 3

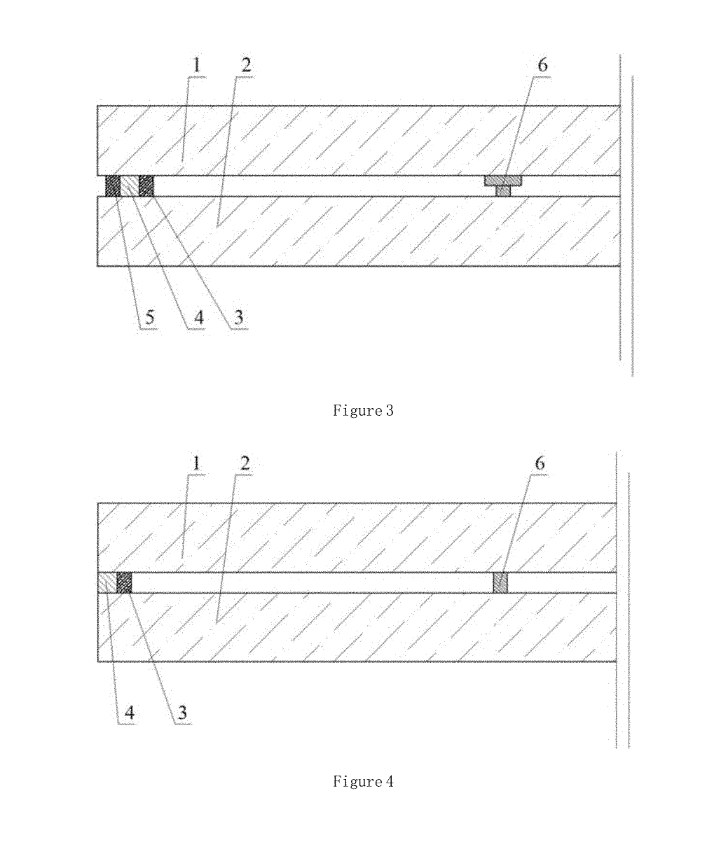

As shown in FIG. 3, a flat vacuum glass comprises three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, and grinding, chamfering, washing, and drying the two pieces of glass; secondly, disposing strip supports 6 on the two pieces of glass using tempered glass ink and a glue dispenser, putting the two pieces of glass into a tempered furnace where the supports are sintered on the glass; mechanically grinding the sintered supports 6 to flatten the tops thereof, and then rounding top edges of the supports so as to eliminate the stress; uniformly coating two layers of low temperature glass solder and one layer of magnesium alloy powders on the periphery of one or two pieces of the glass using a coating machine, the first sealing material 3 and the third sealing material 5 are glass solders, the second sealing material 4 is magnesium alloy powders which are sandwiched between the two layers of the glass solder, the solder comprises a plurality of air extraction holes, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above a softening temperature of 280□ of the low temperature glass solder, following the softening of the low temperature glass solder, sealing the magnesium alloy using the softened low temperature glass solder by gravity or external pressure so as to prevent the volatilization of the magnesium alloy; continuing heating the vacuum furnace to above a melting temperature of 320□ of the magnesium alloy, the magnesium alloy being softened, stopping heating, naturally cooling the furnace, whereby sealing the two pieces of glass by the magnesium alloy, opening a furnace door of the vacuum furnace to obtain the vacuum glass.

The inventive step of the present disclosure lies in that: the vacuum glass of the embodiment comprises three layers of sealing material, prior to the melting of the metal solder, the volatilization is small and is sealed in a fixed space by the softened glass solder, thus avoiding the large quantity of volatilization of the metal solder, prevent the pollution of the glass, vacuum furnace and the vacuum pump, and reducing the loss of the metal solder.

Both the upper glass and the lower glass are provided with strip supports which are vertically disposed, the contact of the upper and lower glass via the supports is point contact, and the contact between the supports and the glass is linear contact, thus increasing the contact area, reducing the stress of the glass in the support positions, so, the quantity of the supports can be reduced, which further improves the transparency, sound and thermal insulation properties of the glass.

### Example 4

As shown in FIG. 4, a flat vacuum glass comprises two sealing layers and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, and grinding, chamfering, washing, and drying the two pieces of glass; secondly, putting the two pieces of glass into a tempered furnace; furthermore, disposing cylindrical supports 6 using polyimide adhesive and a glue dispenser, uniformly coating one layer of polyimide adhesive and one layer of low temperature glass solder on the periphery of one or two pieces of the glass using a coating machine, the first sealing material 3 is the polyimide adhesive, the second sealing material 4 is low temperature glass solder which comprises a plurality of air extraction holes, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above an air extraction temperature of 320□ of the glass, following the extraction of the air in the glass, sealing the vacuum layer using the polyimide adhesive by gravity or external pressure, the supports 6 and the upper and lower glass being tightly contacted; removing the vacuum, continuing heating the vacuum furnace to above a melting temperature of 420□ of the low temperature glass solder, the low temperature glass solder being melted, and the supports 6 being cured on the glass; stopping heating, naturally cooling the furnace, whereby sealing the two pieces of glass by the polyimide adhesive and the low temperature glass solder, opening a furnace door of the vacuum furnace to obtain the vacuum glass.

The inventive step of the present disclosure lies in that: the polyimide supports have good ductility and thermoplasticity and tend to deform under high temperatures and pressure, so all the supports have an appropriate contact with the glass, thus reducing the stress exerted on the glass and the supports, and improving the shock resistance of the vacuum glass.

Sealed by the polyimide, the low temperature glass solder is heated and melted in the air, thus eliminating the effect of the vacuum on the low temperature glass solder.

The double seal makes the vacuum glass has better sealing effect and longer service life.

### Example 5

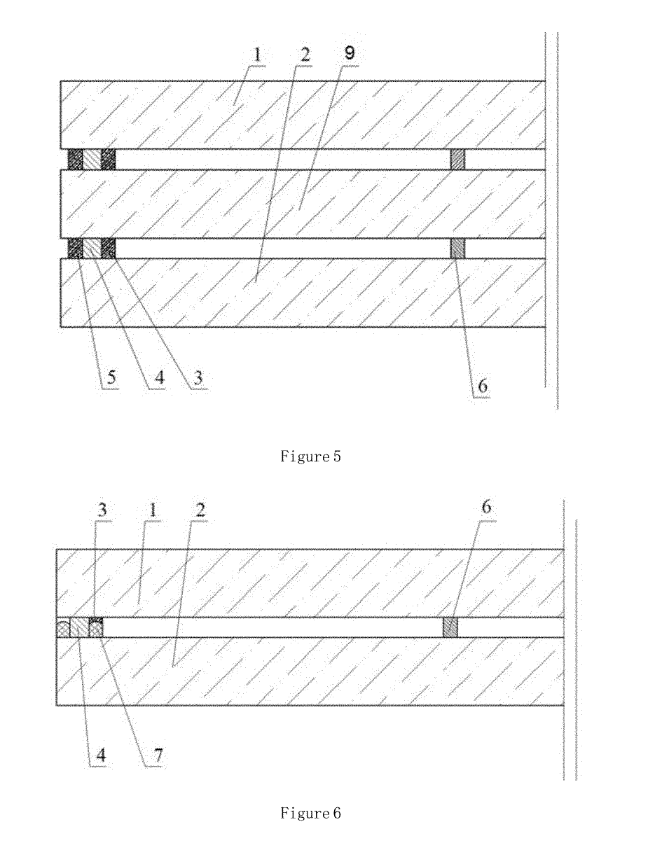

As shown in FIG. 5, vacuum glass comprises three layers of sealing material, two vacuum layers and at least two pieces of tempered glass, one of which is a piece of low emissivity glass. The vacuum glass is manufactured as follows: firstly, cutting and acquiring two pieces of ultra-clear glass and a piece of low emissivity glass all having dimensions corresponding to a desired shape and size of vacuum glass, and grinding, chamfering, washing, and drying the two pieces of glass; secondly, disposing dotted supports 6 on the two pieces of ultra-clear glass using tempered glass ink and a glue dispenser, putting the two pieces of glass into a tempered furnace where the supports 6 are sintered on the glass, performing semi-tempering on the low emissivity glass; mechanically grinding the sintered supports 6 to flatten the tops thereof, and then rounding top edges of the supports so as to eliminate the stress; uniformly coating two layers of low temperature glass solder and one layer of magnesium alloy powder on the periphery of the two or three pieces of the glass using a coating machine, the first sealing material 3 and the third sealing material 5 are low temperature glass solder, the second sealing material 4 ismagnesium alloy powder which is sandwiched between the two layers of low temperature glass solder, the solder comprises a plurality of air extraction holes, merging and sending the three pieces of the glass into a vacuum furnace; pretreating the three pieces of glass prior to or after the merging to remove the gas adsorbed on the glass surface and the volatile substances in the solder; finally, vacuumizing the vacuum furnace to less than 0.1 Pa and heating the vacuum furnace to above a softening temperature of 280□ of the low temperature glass solder, following the softening of the low temperature glass solder, sealing the magnesium alloy using the softened low temperature glass solder by gravity or external pressure so as to prevent the volatilization of the magnesium alloy; continuing heating the vacuum furnace to above a melting temperature of 320□ of the magnesium alloy, the magnesium alloy being melted, stopping heating, naturally cooling the furnace, whereby sealing the three pieces of glass by the magnesium alloy, opening a furnace door of the vacuum furnace to obtain the vacuum glass.

Optionally, the vacuum glass of the embodiment comprises two layers of sealing material, that is, coating one layer of low temperature glass solder 4 and one layer of magnesium alloy powder 3 on the periphery of two or three pieces of the glass using a coating machine, and the magnesium alloy 3 is located in the inner side of the low temperature glass solder 4.

### Example 6

As shown in FIG. 6, a flat vacuum glass comprises two layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, and grinding, chamfering, washing, and drying the two pieces of glass; secondly, disposing two edge-sealing frames 7 on the lower glass 2 using tempered glass ink and a glue dispenser, putting the two pieces of glass into a tempered furnace where the edge-sealing frames 7 are sintered on the glass; preparing cylindrical supports 6 using polyimide adhesive and a glue dispenser, uniformly coating one layer of polyimide adhesive on the edge-sealing frame 7 on the inner side of the lower glass 2, loading the low temperature glass solder in the two edge-sealing frames, the first sealing material 3 is polyimide adhesive, the second sealing material 4 is low temperature glass solder, the solder comprises a plurality of air extraction holes, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above an air extraction temperature of the glass and the softening temperature of the low temperature glass solder of 320□, following the extraction of the air in the glass, sealing the vacuum layer using the polyimide adhesive by gravity or external pressure, the supports 6 and the upper and lower glass being tightly contacted; removing the vacuum, continuing heating the vacuum furnace to above a melting temperature of 420□ of the low temperature glass solder, the low temperature glass solder being softened, and the supports 6 being cured on the glass; stopping heating, naturally cooling the furnace, whereby sealing the two pieces of glass by the polyimide adhesive and the low temperature glass solder, opening a furnace door of the vacuum furnace to obtain the vacuum glass.

### Example 7

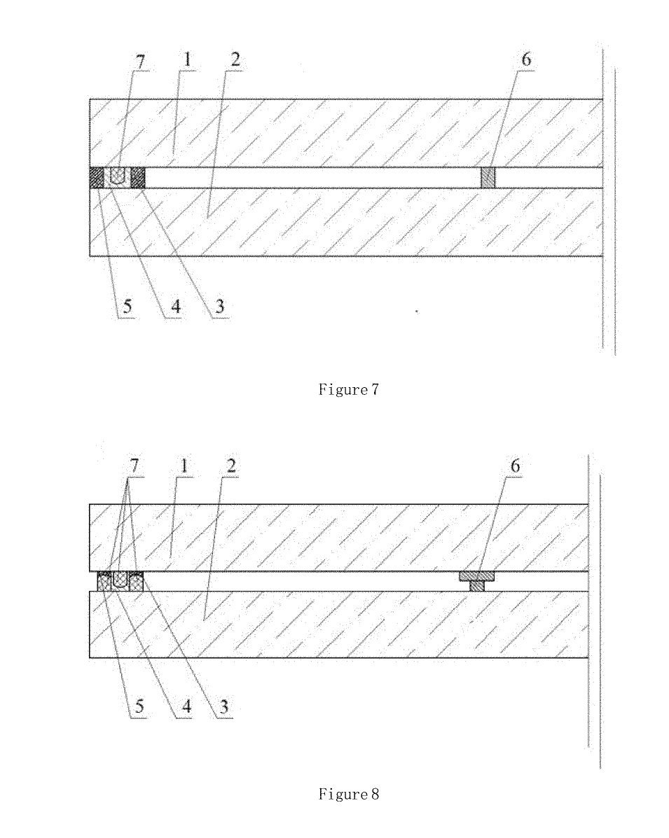

As shown in FIG. 7, vacuum glass comprises an edge-sealing frame, three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, and grinding, chamfering, washing, and drying the two pieces of glass; secondly, disposing cylindrical supports 6 and an edge-sealing frame 7 on the upper glass 1 using tempered glass ink and a glue dispenser, putting the two pieces of glass into a tempered furnace where the supports and the edge-sealing frames are sintered on the glass; mechanically grinding the sintered supports 6 to flatten the tops thereof, and then rounding top edges of the supports so as to eliminate the stress; uniformly coating two layers of low temperature glass solder and one layer of zinc alloy wire on the periphery of one or two pieces of the glass using a coating machine, the first sealing material 3 and the third sealing material 5 are the low temperature glass solder, the second sealing material 4 is the zinc alloy wire which is sandwiched between the two layers of low temperature glass solder and corresponding to the edge-sealing frame 7, the solder comprises a plurality of air extraction holes, placing active metal such as magnesium or aluminum to between the two pieces glass, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above a softening temperature of 320□ of the low temperature glass solder, following the softening of the low temperature glass solder, sealing the zinc alloy powder using the low temperature glass solder by gravity or external pressure so as to prevent the volatilization of the zinc alloy; continuing heating the zinc alloy to above a melting temperature of 380□ thereof, the zinc alloy being melted, stopping heating, naturally cooling the furnace, whereby sealing the two pieces of glass by the zinc alloy, opening a furnace door of the vacuum furnace to obtain the vacuum glass.

### Example 8

As shown in FIG. 8, a flat vacuum glass comprises three layers of sealing material and two pieces of tempered glass having edge-sealing frames, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, and grinding, chamfering, washing, and drying the two pieces of glass; secondly, respectively disposing one and two edge-sealing frames 7 on the upper glass 1 and the lower glass 2 using tempered glass ink and a glue dispenser, the edge-sealing frame 7 on the upper glass is corresponding to the space between the two edge-sealing frames 7 on the lower glass, putting the two pieces of glass into a tempered furnace where the edge-sealing frames 7 are sintered on the glass; disposing strip supports 6 on the upper glass 1 and the lower glass 2 using low temperature glass solder and a glue dispenser, the supports on the upper and lower glass are staggered after the two pieces of glass are merged; uniformly coating polyimide adhesive on the two edge-sealing frames 7 on the lower glass 2 and placing a tin alloy bar in between the two edge-sealing frames, the first sealing material 3 and the third sealing material 5 are polyimide adhesive, the second sealing material 4 is the tin alloy bar, the polyimide adhesive comprises a plurality of air extraction holes, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above a curing temperate of 250□ of the polyimide adhesive, thus the polyimide adhesive being cured; continuing heating the vacuum furnace to above a softening temperature of 320□ of the polyimide adhesive and the low temperature glass solder, the polyimide adhesive and the low temperature glass solder being softened, the softened polyimide adhesive sealing the tin alloy by gravity or external pressure, the upper and lower supports made of low temperature glass solders being staggered; continuing heating the tin alloy to above a melting temperature of 350□ of the tin alloy, the tin alloy being melted, stopping heating, naturally cooling the furnace, whereby sealing the two pieces of glass by the polyimide adhesive and the tin alloy, opening a furnace door of the vacuum furnace to obtain the vacuum glass.

The inventive step of the present disclosure lies in that: the vacuum glass of the embodiment comprises the upper and lower edge-sealing frames and upper and lower supports, thus having good sealing effect and small stress; in addition, the vacuum layer has large height and space, which reduces the conductivity of the supports and improves the thermal and sound insulation properties of the vacuum glass; the large space provides much larger vacuum degree, facilitates the placement of more quantity of gas absorbent, thus prolonging the service life of the vacuum glass.

### Example 9

As shown in FIG. 9, a flat vacuum glass comprises an edge-sealing groove, three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, disposing an edge-sealing groove 8 on one piece of glass, and grinding, chamfering, washing, and drying the two pieces of glass; secondly, putting the two pieces of glass into a tempered furnace; preparing linear supports 6 using polyimide adhesive and a glue dispenser, the supports on the upper and lower glass are staggered after the two pieces of glass are merged; uniformly coating two layers of low temperature glass solder and one layer of magnesium alloy powder on the periphery of one or two pieces of the glass using a coating machine, the magnesium alloy powder being sandwiched between the two layers of low temperature glass solder and corresponding to the edge-sealing groove 8, the first sealing material 3 and the third sealing material 5 are low temperature glass solder, the second sealing material 4 is magnesium alloy powder, the solder comprises a plurality of air extraction holes, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above a softening temperature of the low temperature glass solder of 280□, following the softening of the low temperature glass solder, sealing the magnesium alloy using the softened low temperature glass solder by gravity or external pressure so as to prevent the volatilization of the magnesium alloy; continuing heating the vacuum furnace to above a melting temperature of 320□ of the magnesium alloy, the magnesium alloy being melted; stopping heating, naturally cooling the furnace, whereby sealing the two pieces of glass by the magnesium alloy, opening a furnace door of the vacuum furnace to obtain the vacuum glass.

The inventive step of the present disclosure lies in that: the arrangement of the edge-sealing groove transforms the plane sealing of the glass into curve sealing, and can flexibly control the thickness of the vacuum layer; the linear and ductile supports prepared by the polyimide adhesives enhance the shock resistance of the vacuum glass, and when the glass breaks, the supports can adhere to the glass fragments and prevent the falling of the glass, thus further enhancing the safety of the glass.

### Example 10

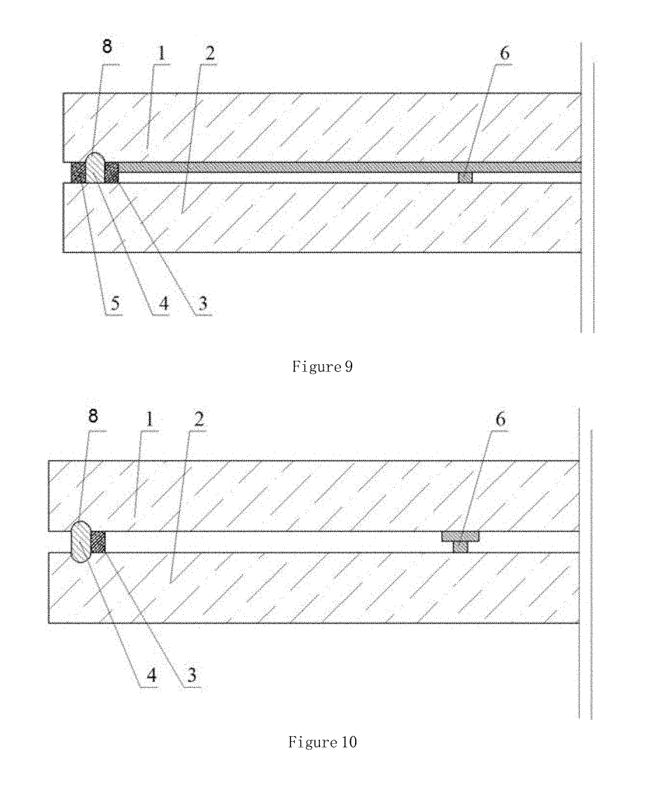

As shown in FIG. 10, a flat vacuum glass comprises two edge-sealing grooves, two layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, disposing corresponding edge-sealing grooves 8 on the upper and lower glass, respectively, and grinding, chamfering, washing, and drying the two pieces of glass; secondly, disposing strip supports 6 on the two pieces of glass using tempered glass ink and a glue dispenser, the supports on the upper and lower glass are staggered after the two pieces of glass are merged; putting the two pieces of glass into a tempered furnace where the supports 6 are sintered on the glass; mechanically grinding the sintered supports 6 to flatten the tops thereof, and then rounding top edges of the supports so as to eliminate the stress; uniformly coating one layer of silicone adhesive on the inner side of the edge-sealing grooves 8 of one or two pieces of glass, the low temperature glass solder being loaded in the edge-sealing grooves 8, the first sealing material 3 is silicone adhesive, and the second sealing material 4 is low temperature glass solder, the solder comprises a plurality of air extraction holes, placing an active metal or gas absorbent in between the two pieces of the glass, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above an air extraction temperature of 300□ of the glass, holding the temperature, sealing the vacuum layer using the silicone adhesive by gravity or external pressure; removing the vacuum, continuing heating the vacuum furnace to above a melting temperature of 420□ of the low temperature glass solder, the c low temperature glass solder being melted, stopping heating, naturally cooling the furnace, whereby sealing the two pieces of glass by the silicone adhesive and the low temperature glass solder, opening a furnace door of the vacuum furnace to obtain the vacuum glass.

### Example 11

As shown in FIG. 11, a flat vacuum glass comprises two edge-sealing grooves, three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, disposing two edge-sealing grooves 8 on the upper glass 1, and grinding, chamfering, washing, and drying the two pieces of glass; secondly, putting the two pieces of glass into a tempered furnace, preparing cylindrical supports 6 using polyimide adhesive and a glue dispenser; uniformly coating two layers of polyimide adhesive and one layer of magnesium alloy powder on the periphery of one or two pieces of the glass using a coating machine, the magnesium alloy powder being sandwiched between the two layers of polyimide adhesive which are corresponding to the two edge-sealing grooves 8, the first sealing material 3 and the third sealing material 5 are polyimide adhesive, the second sealing material 4 is magnesium alloy powder, the solder comprises a plurality of air extraction holes, placing an active metal or gas absorbent in between the two pieces of the glass, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above an air extraction temperature of 300□ of the glass, holding the temperature, sealing the magnesium alloy using the polyimide adhesive by gravity or external pressure, so as to prevent the volatilization of the magnesium alloy; continuing heating the vacuum furnace to above a melting temperature of 350□ of the magnesium alloy, the magnesium alloy being melted; stopping heating, naturally cooling the furnace, whereby sealing the two pieces of glass by the magnesium alloy and the polyimide adhesive, opening a furnace door of the vacuum furnace to obtain the vacuum glass.

The inventive step of the present disclosure lies in that: the arrangement of the edge-sealing groove transforms the plane sealing of the glass into curve sealing, and can flexibly control the thickness of the vacuum layer; the ductile supports prepared by the polyimide adhesives are easy to make, have good thermal insulation properties, and enhance the shock resistance of the vacuum glass.

### Example 12

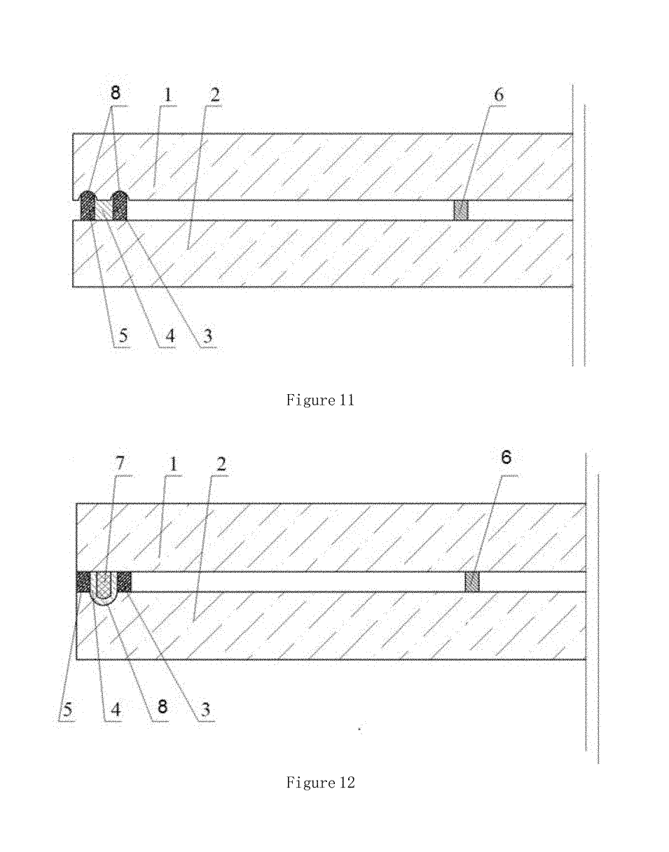

As shown in FIG. 12, a flat vacuum glass comprises an edge-sealing frame, an edge-sealing groove, three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, disposing an edge-sealing groove 8 on the lower glass 2, and grinding, chamfering, washing, and drying the two pieces of glass; secondly, disposing an edge-sealing frame 7 on the upper glass 1 using tempered glass ink and glue dispenser, the edge-sealing frame 7 is corresponding to the edge-sealing groove 8, then putting the two pieces of glass into a tempered furnace where the prepared edge-sealing frame 7 is sintered on the upper glass 1; preparing cylindrical supports 6 using polyimide adhesive and a glue dispenser; uniformly coating two layers of silicone adhesive and one layer of tin alloy powder on the periphery of one or two pieces of the glass using a coating machine, the tin alloy powder 4 being disposed in the edge-sealing groove 8 sandwiched between the two layers of silicone adhesive, the first sealing material 3 and the third sealing material 5 are silicone adhesive, the second sealing material 4 is tin alloy powder, the solder comprises a plurality of air extraction holes; placing an active metal or gas absorbent in between the two pieces of the glass, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above an air extraction temperature of 300□ of the glass, holding the temperature, sealing the tin alloy using the silicone adhesive by gravity or external pressure so as to prevent the volatilization of the tin alloy, the supports 6 and the upper and lower glass being tightly contacted; continuing heating the vacuum furnace to above a melting temperature of 350□ of the tin alloy, the tin alloy being melted, and the supports 6 being cured on the glass; stopping heating, naturally cooling the furnace, whereby sealing the two pieces of glass by the tin alloy and silicone adhesive, opening a furnace door of the vacuum furnace to obtain the vacuum glass.

### Example 13

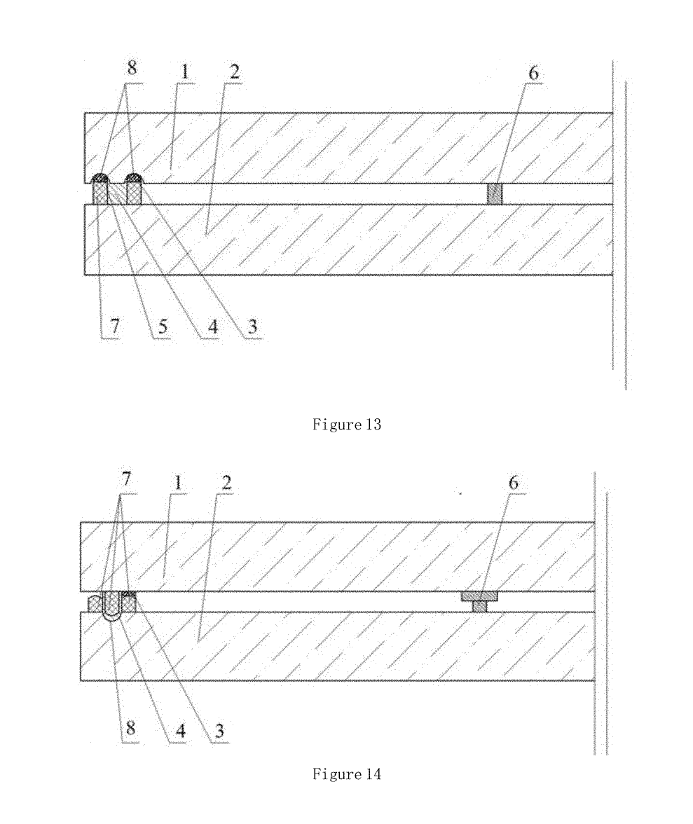

As shown in FIG. 13, a flat vacuum glass comprises two edge-sealing frames, two edge-sealing grooves, three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, disposing two edge-sealing grooves 8 on the upper glass 1, and grinding, chamfering, washing, and drying the two pieces of glass; secondly, disposing two edge-sealing frames 7 on the lower glass 2 using tempered glass ink and glue dispenser, the edge-sealing frames 7 are corresponding to the edge-sealing grooves 8; preparing dotted supports 6 on one piece of glass using tempered glass ink and a glue dispenser, then putting the two pieces of glass into a tempered furnace where the prepared edge-sealing frames 7 and the supports are sintered on the glass; mechanically grinding the sintered supports 6 to flatten the tops thereof, and then rounding top edges of the supports so as to eliminate the stress; uniformly coating two layers of polyimide adhesive on the two edge-sealing frames 7, loading magnesium alloy powders to between the two edge-sealing frames 7, the first sealing material 3 and the third sealing material 5 are polyimide adhesive, the second sealing material 4 is magnesium alloy powder, the solder comprises a plurality of air extraction holes; merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above an air extraction temperature of 280□ of the glass, holding the temperature, sealing the magnesium alloy using the polyimide adhesive by gravity or external pressure so as to prevent the volatilization of the magnesium alloy; continuing heating the vacuum furnace to above a melting temperature of 320□ of the magnesium alloy, the magnesium alloy being melted; stopping heating, naturally cooling the furnace, whereby sealing the two pieces of glass by the magnesium alloy, opening a furnace door of the vacuum furnace to obtain the vacuum glass.

### Example 14

As shown in FIG. 14, a flat vacuum glass comprises two layers of sealing material and two pieces of tempered glass having edge-sealing frames, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, disposing an edge-sealing groove 8 on the lower glass 2, and grinding, chamfering, washing, and drying the two pieces of glass; secondly, respectively disposing one and two edge-sealing frames 7 on the upper glass 1 and the lower glass 2 using tempered glass ink and a glue dispenser, the edge-sealing frame 7 on the upper glass is corresponding to the space between the two edge-sealing frames 7 on the lower glass, and corresponding to the edge-sealing groove 8; putting the two pieces of glass into a tempered furnace where the edge-sealing frames 7 are sintered on the glass; disposing strip supports 6 on the upper glass 1 and the lower glass 2 using low temperature glass solder and a glue dispenser, the supports on the upper and lower glass are staggered after the two pieces of glass are merged; uniformly coating polyimide adhesive on the edge-sealing frame 7 on the inner side of the lower glass 2 and placing a low temperature glass solder in between the two edge-sealing frames 7, the first sealing material 3 is polyimide adhesive, the second sealing material 4 is the low temperature glass solder, the polyimide adhesive comprises a plurality of air extraction holes, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above an air extraction temperature of the glass of 320□, the polyimide adhesive and the low temperature glass solder being softened, sealing the vacuum layer using the softened polyimide adhesive by gravity or external pressure; the supports on the upper and lower glass made of low temperature glass solder are staggered; removing the vacuum, continuing heating the glass solder to above a melting temperature of 420□ of the glass solder, the glass solder being melted, stopping heating, naturally cooling the furnace, whereby sealing the two pieces of glass by the polyimide adhesive and the glass solder, opening a furnace door of the vacuum furnace to obtain the vacuum glass.

The inventive step of the present disclosure lies in that: the vacuum glass of the embodiment comprises the upper and lower edge-sealing frames and upper and lower supports, thus having good sealing effect and small stress; in addition, the vacuum layer has large height and space, which reduces the conductivity of the supports and improves the thermal and sound insulation properties of the vacuum glass; the large space provides much larger vacuum degree, facilitates the placement of more quantity of gas absorbent, thus prolonging the service life of the vacuum glass.

### Example 15

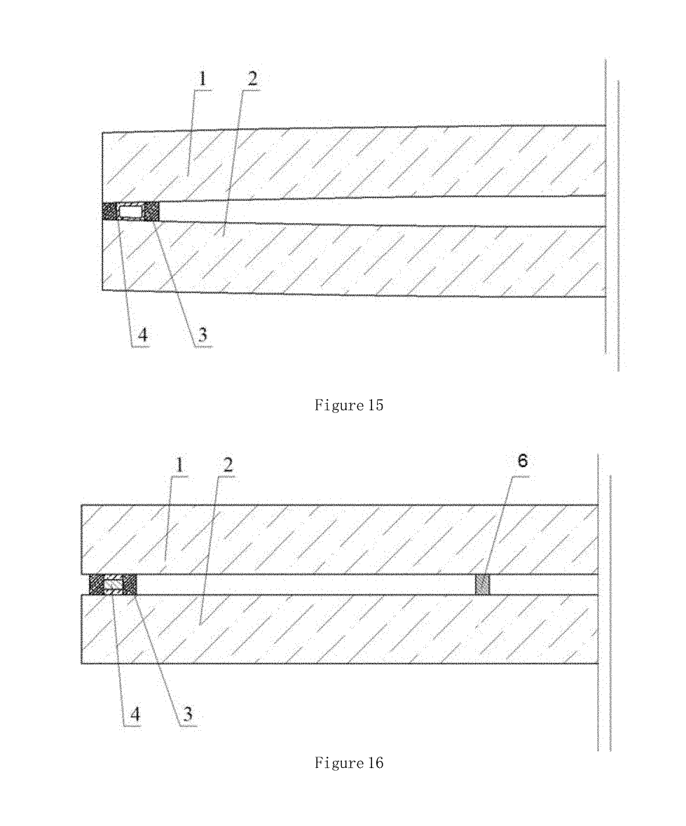

As shown in FIG. 15, a convex vacuum glass, which is sealed by adhesive, comprises a piece of upper convex glass 1 and a piece of lower convex glass 2. The peripheries of the two pieces of glass are sealed by two layers of adhesive 3, and a vacuum layer is disposed therebetween. The vacuum glass is manufactured as follows: firstly, cutting and acquiring two pieces of flat glass having dimensions corresponding to a desired shape and size of vacuum glass, loading the two pieces of flat glass to a mold and placing in a hot bending furnace, heating the furnace to the glass softening temperature of 550-750□, thus convex surfaces being formed downwards due to the gravity of the glass, naturally cooling the furnace down to room temperature; uniformly coating two layers of silicone adhesive on the periphery of one or two pieces of the glass using a coating machine, uniformly disposing magnesium powder between the two layers of silicone adhesive, the first sealing material 3 and the third sealing material 5 are silicone adhesive, the second sealing material 4 is magnesium powder, the silicone adhesive comprises a plurality of air extraction holes; merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above a bonding temperature of 220□ of the adhesive, sealing the vacuum layer using the silicone adhesive by gravity or external pressure; continuing heating the vacuum furnace to above a volatilization temperature of 300□ of the magnesium powder, evaporation coating under vacuum; stopping heating, naturally cooling the furnace, whereby sealing the two pieces of glass by the silicone adhesive and metal coating, opening a furnace door of the vacuum furnace to obtain the vacuum glass.

### Example 16

As shown in FIG. 16, a flat vacuum glass comprises three sealing layers and two pieces of tempered glass, one of which is a piece of low emissivity glass. The vacuum glass comprises a piece of upper glass 1, a piece of lower glass 2, and a closed vacuum layer sandwiched between the upper glass 1 and the lower glass 2. The peripheries of the two pieces of glass are welded using two layers of polyimide adhesive 3 and one layer of metal solder 4. The vacuum glass is manufactured as follows: firstly, cutting and acquiring two pieces of flat glass having dimensions corresponding to a desired shape and size of vacuum glass, and grinding, chamfering, washing, and drying the two pieces of glass; secondly, disposing supports 6 on the upper glass 1 using tempered glass ink and a glue dispenser, coating silver paste on the welding surface of the metal solder of the two pieces of glass, putting the two pieces of glass into a tempered furnace where the prepared supports and coated silver slurry are also sintered on the glass; mechanically grinding the sintered supports 6 to flatten the tops thereof, and then rounding top edges of the supports 6 so as to eliminate the stress; uniformly coating polyimide adhesive and tin alloy soldering paste on the periphery of one or two pieces of the glass using a coating machine, the first sealing material 3 and the third sealing material 5 are polyimide adhesive, the second sealing material 4 is the tin alloy paste, the adhesive comprises a plurality of air extraction holes, placing a gas absorbent in between the two pieces of the glass, merging and sending the two pieces of the glass into a vacuum furnace; pretreating the two pieces of glass prior to or after the merging to remove the gas adsorbed on the glass surface and the volatile substances in the adhesive; finally, vacuumizing the vacuum furnace to less than 0.1 Pa and heating the vacuum furnace to above a curing temperature of 250□ of the polyimide, the gas absorbent being activated under high temperature and high vacuum, sealing the vacuum layer using the polyimide adhesive which is cured and softened by gravity or external pressure; continuing heating the vacuum furnace to above a melting temperature of 280□ of the tin alloy, the tin alloy being melted, stopping heating, naturally cooling the furnace, whereby sealing the two pieces of glass by the adhesive and the tin alloy, opening a furnace door of the vacuum furnace to obtain the vacuum glass.

### Example 17

As shown in FIG. 3, a flat vacuum glass comprises three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, and grinding, chamfering, washing, and drying the two pieces of glass; secondly, disposing strip supports 6 on the two pieces of glass using tempered glass ink and a glue dispenser, putting the two pieces of glass into a tempered furnace where the supports are sintered on the glass; mechanically grinding the sintered supports 6 to flatten the tops thereof, and then rounding top edges of the supports so as to eliminate the stress; uniformly coating two layers of polyaryletherketone and one layer of low temperature glass solder on the periphery of one or two pieces of the glass using a coating machine, the low temperature glass solder being sandwiched between the two layers of polyaryletherketone; the first sealing material 3 and the third sealing material 5 are polyaryletherketone adhesive, the second sealing material 4 is low temperature glass solder, the solder comprises a plurality of air extraction holes, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above the melting temperature of polyaryletherketone and the softening temperature of the low temperature glass solder of 340□, sealing the vacuum layer using the melted polyaryletherketone and the softened low temperature glass solder by gravity or external pressure, stopping heating, naturally cooling the furnace, whereby sealing the two pieces of glass by the polyaryletherketone and the low temperature glass solder, opening a furnace door of the vacuum furnace to obtain the vacuum glass.

### Example 18

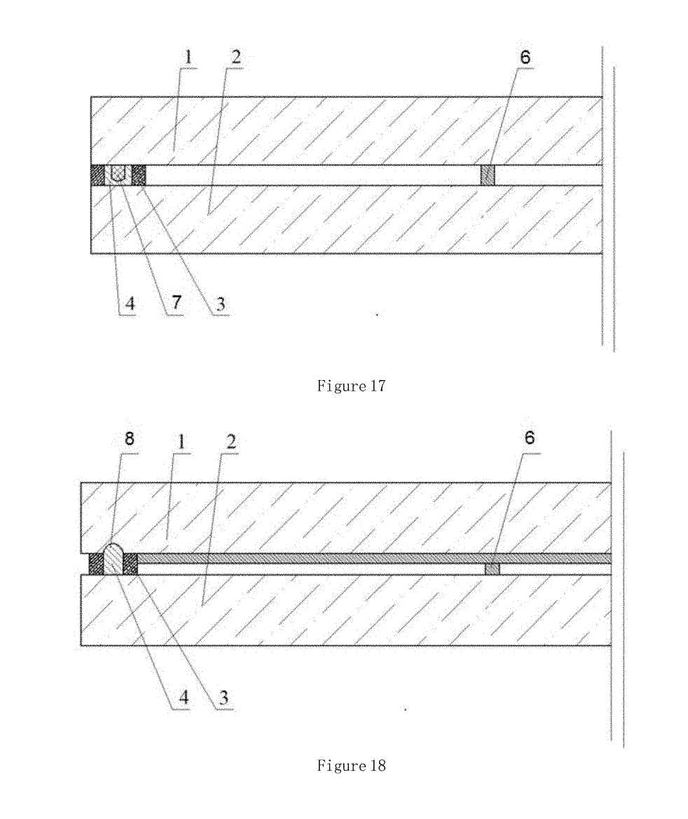

As shown in FIG. 17, vacuum glass comprises an edge-sealing frame, three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, and grinding, chamfering, washing, and drying the two pieces of glass; secondly, disposing cylindrical supports 6 and an edge-sealing frame 7 on the upper glass 1 using tempered glass ink and a glue dispenser, putting the two pieces of glass into a tempered furnace where the supports 6 and the edge-sealing frames 7 are sintered on the glass; uniformly coating two layers of polyimide adhesive and one layer of zinc alloy wire on the periphery of one or two pieces of the glass using a coating machine, the first sealing material 3 and the third sealing material 5 are polyimide adhesive, the second sealing material 4 is the zinc alloy wire which is sandwiched between the two layers of polyimide adhesive and corresponding to the edge-sealing frame 7, the solder comprises a plurality of air extraction holes, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above a gelling and softening temperature of 350□ of the polyimide, following the softening of the polyimide, sealing the zinc alloy powder using the softened polyimide by gravity or external pressure so as to prevent the volatilization of the zinc alloy; continuing heating the zinc alloy to above a melting temperature of 380□ thereof, the zinc alloy being melted, stopping heating, naturally cooling the furnace, whereby sealing the two pieces of glass by the zinc alloy, opening a furnace door of the vacuum furnace to obtain the vacuum glass.

The inventive step of the present disclosure lies in that: the arrangement of the edge-sealing groove transforms the plane sealing of the two pieces of glass into curve sealing, thus improving the airtightness, firmness and reliability of the sealing of the vacuum glass.

### Example 19

As shown in FIG. 18, a flat vacuum glass comprises an edge-sealing groove, three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, disposing an edge-sealing groove 8 on one piece of glass, and grinding, chamfering, washing, and drying the two pieces of glass; secondly, putting the two pieces of glass into a tempered furnace; preparing linear supports 6 using polyimide adhesive and a glue dispenser, the supports on the upper and lower glass are staggered after the two pieces of glass are merged; uniformly coating two layers of silicone adhesive and one layer of magnesium alloy powder on the periphery of one or two pieces of the glass using a coating machine, the magnesium alloy powder being sandwiched between the two layers of silicone adhesive and corresponding to the edge-sealing groove 8, the first sealing material 3 and the third sealing material 5 are silicone adhesive, the second sealing material 4 is magnesium alloy powder, the silicone adhesive comprises a plurality of air extraction holes, merging and sending the two pieces of the glass into a vacuum furnace; pretreating the two pieces of glass prior to or after the merging to remove the gas adsorbed on the glass surface and the volatile substances in the silicone adhesive; finally, vacuumizing the vacuum furnace to less than 0.1 Pa and heating the vacuum furnace to above a gelling temperature of the silicone adhesive of 280□, sealing the magnesium alloy using the silicone adhesive by gravity or external pressure so as to prevent the volatilization of the magnesium alloy; continuing heating the vacuum furnace to above a melting temperature of 320□ of the magnesium alloy, the magnesium alloy being melted; stopping heating, naturally cooling the furnace, whereby sealing the two pieces of glass by the silicone adhesive and magnesium alloy, opening a furnace door of the vacuum furnace to obtain the vacuum glass.

The inventive step of the present disclosure lies in that: the arrangement of the edge-sealing groove transforms the plane sealing of the glass into curve sealing, and can flexibly control the thickness of the vacuum layer; the linear and ductile supports prepared by the polyimide adhesives enhance the shock resistance of the vacuum glass, and when the glass breaks, the supports can adhere to the glass fragments and prevent the falling of the glass, thus further enhancing the safety of the glass.

### Example 20

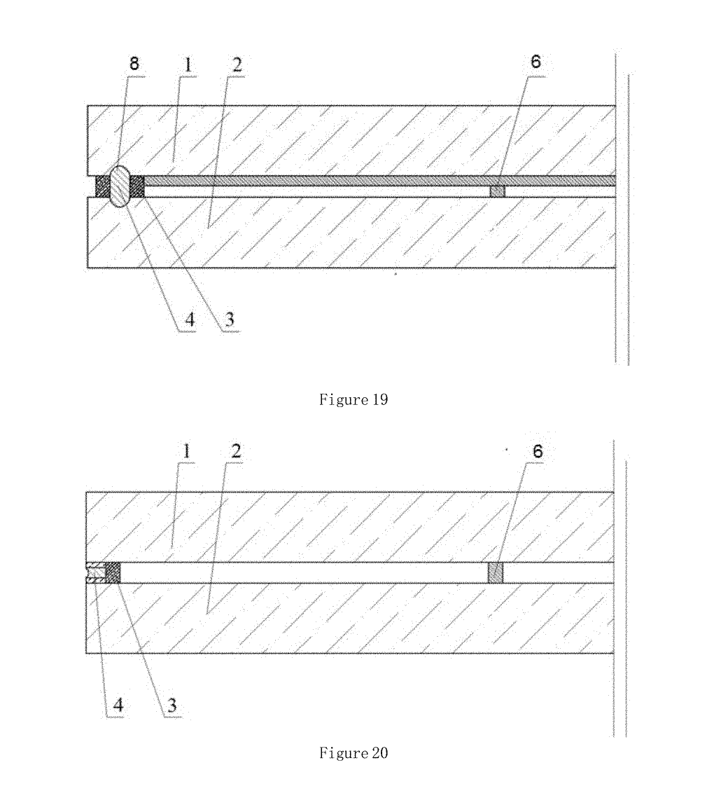

As shown in FIG. 19, a flat vacuum glass comprises two edge-sealing grooves and three layers of sealing material; the flat vacuum glass is basically the same as that in Example 19 except that: the lower glass 2 comprises an edge-sealing groove 8 corresponding to the edge-sealing groove 8 on the upper glass 1, thus further strengthening the sealing effect.

### Example 21

As shown in FIG. 11, a flat vacuum glass comprises two edge-sealing grooves, three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, disposing two edge-sealing grooves 8 on the upper glass 1, and grinding, chamfering, washing, and drying the two pieces of glass; secondly, preparing dotted supports 6 using tempered glass ink and a glue dispenser on one piece of glass, putting the two pieces of glass into a tempered furnace where the supports are sintered on the glass; mechanically grinding the sintered supports 6 to flatten the tops thereof, and then rounding top edges of the supports so as to eliminate the stress; uniformly coating two layers of high temperature epoxy resin adhesive and one layer of magnesium alloy powder on the periphery of one or two pieces of the glass using a coating machine, the first sealing material 3 and the third sealing material 5 are the epoxy resin adhesive, the second sealing material 4 is magnesium alloy powder, the two layers of epoxy resin adhesive are corresponding to the two edge-sealing grooves 8, respectively, and the magnesium alloy powder is sandwiched between the two layers of glass solders; the rest is the same as that in Example 19.

### Example 22

As shown in FIG. 12, a flat vacuum glass comprises an edge-sealing frame, an edge-sealing groove, three layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, disposing an edge-sealing groove 8 on the lower glass 2, and grinding, chamfering, washing, and drying the two pieces of glass; secondly, disposing an edge-sealing frame 7 on the upper glass 1 using tempered glass ink and glue dispenser, the edge-sealing frame 7 is corresponding to the edge-sealing groove 8, then putting the two pieces of glass into a tempered furnace where the prepared edge-sealing frame 7 is sintered on the upper glass 1; preparing cylindrical supports 6 using polyimide adhesive and a glue dispenser; uniformly coating two layers of polyimide adhesive and one layer of low temperature glass solder on the periphery of one or two pieces of the glass using a coating machine, the low temperature glass solder being disposed in the edge-sealing groove 8 sandwiched between the two layers of polyimide adhesive, the first sealing material 3 and the third sealing material 5 are polyimide adhesive, the second sealing material 4 is low temperature glass solder, the solder comprises a plurality of air extraction holes; merging and sending the two pieces of the glass into a vacuum furnace; pretreating the two pieces of glass prior to or after the merging to remove the gas adsorbed on the glass surface and the volatile substances in the adhesive; finally, vacuumizing the vacuum furnace to less than 0.1 Pa and heating the vacuum furnace to above a gelling temperature of 300□ of the polyimide adhesive, sealing the low temperature glass solder using the polyimide adhesive by gravity or external pressure so as to prevent the gas release, bubbling or carbonization of the low temperature glass solder 5 under vacuum; the supports 6 and the upper and lower glass being tightly contacted; continuing heating the vacuum furnace to above a melting temperature of 380□ of the low temperature glass solder 5, the low temperature glass solder 5 being melted, and the supports 6 being cured on the glass; stopping heating, naturally cooling the furnace, whereby sealing the two pieces of glass by the low temperature glass solder and polyimide adhesive, opening a furnace door of the vacuum furnace to obtain the vacuum glass.

### Example 23

As shown in FIG. 5, vacuum glass comprises three layers of sealing material, two vacuum layers and at least two pieces of tempered glass, one of which is a piece of low emissivity glass. The vacuum glass is manufactured as follows: firstly, cutting and acquiring two pieces of ultra-clear glass and a piece of low emissivity glass all having dimensions corresponding to a desired shape and size of vacuum glass, and grinding, chamfering, washing, and drying the two pieces of glass; secondly, disposing dotted supports 6 on the two pieces of ultra-clear glass using tempered glass ink and a glue dispenser, putting the two pieces of glass into a tempered furnace where the supports are sintered on the glass, performing semi-tempering on the low emissivity glass; mechanically grinding the sintered supports 6 to flatten the tops thereof, and then rounding top edges of the supports so as to eliminate the stress; uniformly coating two layers of silicone adhesive and one layer of magnesium alloy powder on the periphery of the two or three pieces of the glass using a coating machine, the first sealing material 3 and the third sealing material 5 are low temperature glass solder, the second sealing material 4 is magnesium alloy powder which is sandwiched between the two layers of silicone adhesive, the adhesive comprises a plurality of air extraction holes, merging and sending the three pieces of the glass into a vacuum furnace; pretreating the three pieces of glass prior to or after the merging to remove the gas adsorbed on the glass surface and the volatile substances in the adhesive; finally, vacuumizing the vacuum furnace to less than 0.1 Pa and heating the vacuum furnace to above a gelling temperature of 280□ of the silicone adhesive 3, sealing the magnesium alloy using the silicone adhesive by gravity or external pressure so as to prevent the volatilization of the magnesium alloy; continuing heating the vacuum furnace to above a melting temperature of 320□ of the magnesium alloy, the magnesium alloy being melted, stopping heating, naturally cooling the furnace, whereby sealing the three pieces of glass by the magnesium alloy and silicone adhesive, opening a furnace door of the vacuum furnace to obtain the vacuum glass.

### Example 24

As shown in FIG. 20, a flat vacuum glass comprises two sealing layers and two pieces of tempered glass, one of which is a piece of low emissivity glass. The vacuum glass comprises a piece of upper glass 1, a piece of lower glass 2, and a closed vacuum layer sandwiched between the upper glass 1 and the lower glass 2. The peripheries of the two pieces of glass are welded using one layer of polyimide adhesive 3 and one layer of metal solder 4. The vacuum glass is manufactured as follows: firstly, cutting and acquiring two pieces of flat glass having dimensions corresponding to a desired shape and size of vacuum glass, and grinding, chamfering, washing, and drying the two pieces of glass; secondly, disposing supports 6 on the upper glass 1 using tempered glass ink and a glue dispenser, coating silver paste on the welding surface of the metal solder of the two pieces of glass, putting the two pieces of glass into a tempered furnace where the prepared supports and coated silver slurry are also sintered on the glass; mechanically grinding the sintered supports 6 to flatten the tops thereof, and then rounding top edges of the supports so as to eliminate the stress; uniformly coating polyimide adhesive and tin alloy soldering paste on the periphery of one or two pieces of the glass using a coating machine, the solder comprises a plurality of air extraction holes, placing a gas absorbent in between the two pieces of the glass, merging and sending the two pieces of the glass into a vacuum furnace; pretreating the two pieces of glass prior to or after the merging to remove the gas adsorbed on the glass surface and the volatile substances in the solder; finally, vacuumizing the vacuum furnace to less than 0.1 Pa and heating the vacuum furnace to above a curing temperature of 250□ of the polyimide, the gas absorbent being activated under high temperature and high vacuum, sealing the vacuum layer using the polyimide adhesive which is cured and softened by gravity or external pressure; continuing heating the vacuum furnace to above a melting temperature of 280□ of the tin alloy, the tin alloy being softened, stopping heating, naturally cooling the furnace, whereby sealing the two pieces of glass by the tin alloy, opening a furnace door of the vacuum furnace to obtain the vacuum glass.

### Example 25

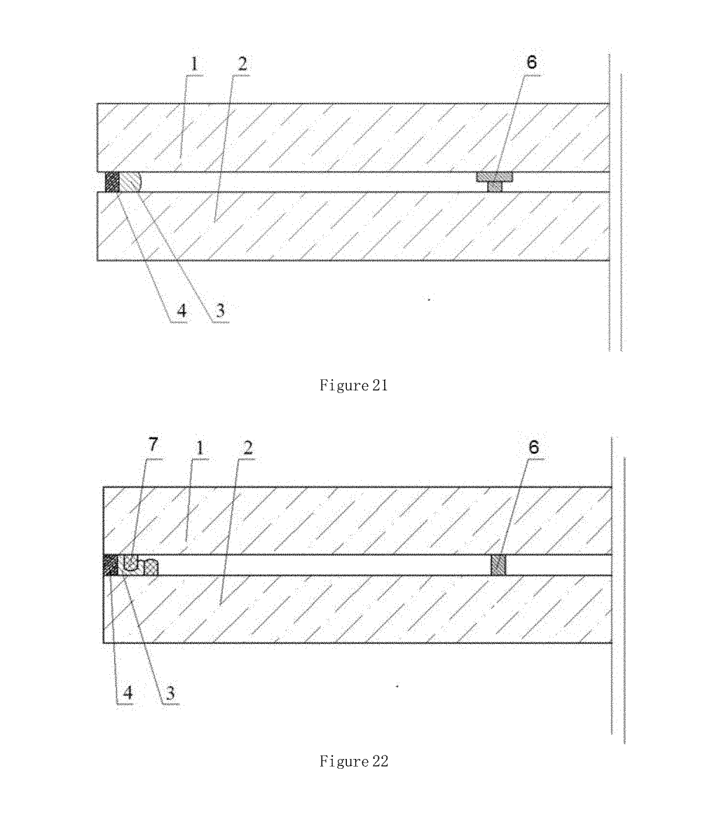

As shown in FIG. 21, a flat vacuum glass insulation board comprises two layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, and grinding, chamfering, washing, and drying the two pieces of glass; secondly, disposing strip supports 6 on the two pieces of glass using tempered glass ink and a glue dispenser, the supports on the upper and lower glass are staggered after the two pieces of glass are merged; putting the two pieces of glass into a tempered furnace where the supports 6 are sintered on the glass; mechanically grinding the sintered supports 6 to flatten the tops thereof, and then rounding top edges of the supports so as to eliminate the stress; uniformly coating one layer of magnesium alloy powder and one layer of low temperature glass solder on the peripheries of one or two pieces of glass using a coating machine, the first sealing material 3 is magnesium alloy powder, and the second sealing material 4 is low temperature glass solder, the solder comprises a plurality of air extraction holes, merging and sending the two pieces of the glass into a vacuum furnace; pretreating the two pieces of glass prior to or after the merging to remove the volatile substances in the solder; finally, vacuumizing the vacuum furnace to less than 0.1 Pa and heating the vacuum furnace to above a softening temperature of 280□ of the low temperature glass solder, following the softening of the low temperature glass solder, sealing the vacuum layer using the low temperature glass solder by gravity or external pressure; continuing heating the vacuum furnace to above a melting temperature of 320□ of the magnesium alloy, the magnesium alloy being melted, stopping heating, naturally cooling the furnace, whereby sealing the two pieces of glass by the magnesium alloy, simultaneously, the magnesium volatiles under high temperature and vacuum to react with oxygen and nitrogen, which increases the vacuum degree and coats the vacuum layer, opening a furnace door of the vacuum furnace to obtain the vacuum glass insulation board.

### Example 26

As shown in FIG. 22, a flat vacuum glass insulation board comprises edge-sealing frames, two layers of sealing material and two pieces of tempered glass, one of which is a piece of low emissivity glass. The vacuum glass is manufactured as follows: firstly, cutting and acquiring a piece of flat glass and a piece of low emissivity glass both having dimensions corresponding to a desired shape and size of vacuum glass, and grinding, chamfering, washing, and drying the two pieces of glass; secondly, disposing edge-sealing frames 7 on the upper glass 1 and the lower glass 2 using tempered glass ink and a glue dispenser, disposing cylindrical supports 6 on the upper glass 1 using tempered glass ink and the glue dispenser, putting the two pieces of glass into a tempered furnace where the supports 6 and the edge-sealing frames 7 are sintered on the glass; uniformly coating one layer of low temperature glass solder and one layer of zinc alloy wire on the periphery of one or two pieces of the glass using a coating machine, the first sealing material 3 is zinc alloy wire, the second sealing material 4 is the low temperature glass solder, and the zinc alloy wire is sandwiched between the low temperature glass solder and the edge-sealing frame 7 on the lower glass 2 and is corresponding to the edge-sealing frame 7 on the upper glass 1, the solder comprises a plurality of air extraction holes, merging and sending the two pieces of the glass into a vacuum furnace; pretreating the two pieces of glass prior to or after the merging to remove the volatile substances in the solder; finally, vacuumizing the vacuum furnace to less than 0.1 Pa and heating the vacuum furnace to above a softening temperature of 350□ of the low temperature glass solder, following the softening of the low temperature glass solder, sealing the zinc alloy powder using the low temperature glass solder by gravity or external pressure so as to prevent the volatilization of the zinc alloy; continuing heating the zinc alloy to above a melting temperature of 380□ of the zinc alloy, the zinc alloy being melted, stopping heating, naturally cooling the furnace, whereby sealing the two pieces of glass by the zinc alloy, simultaneously, the zinc volatiles under high temperature and vacuum to react with oxygen and nitrogen, which increases the vacuum degree and coats the vacuum layer, opening a furnace door of the vacuum furnace to obtain the vacuum glass insulation board.

### Example 27

As shown in FIG. 23, the example is basically the same as that in example 19 except that the periphery of one or two pieces of glass is sealed by two layers of sealing material, the first layer of sealing material 3 is magnesium alloy powder, the second layer of sealing material 4 is polyimide adhesive, the layer of magnesium alloy powder and the layer of polyimide adhesive are uniformly coated, and the magnesium alloy powder is located in the edge-sealing grooves 8.

### Example 28

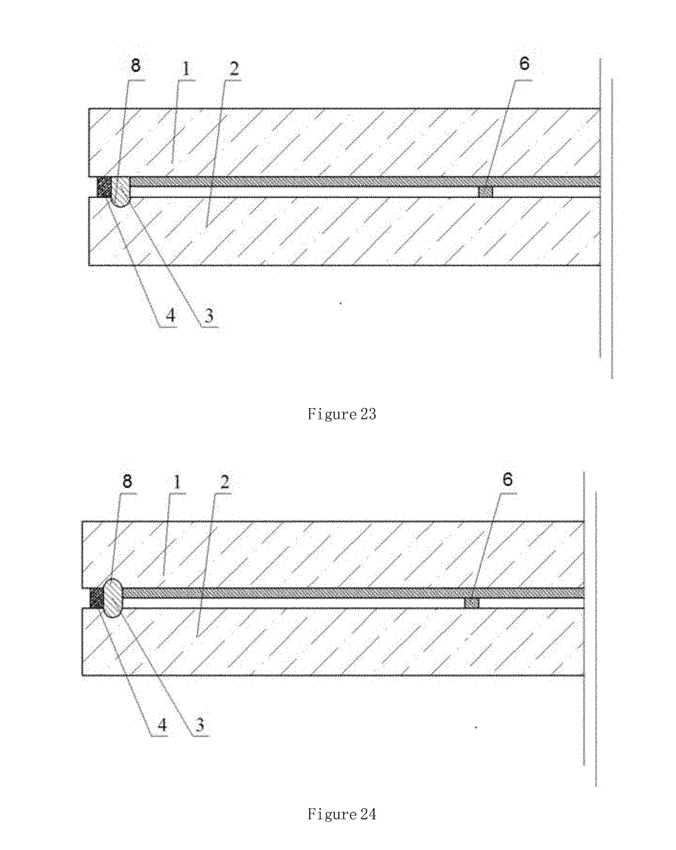

As shown in FIG. 24, the example is basically the same as that in example 20 except that the periphery of one or two pieces of glass is sealed by two layers of sealing material, the first layer of sealing material 3 is magnesium alloy powder, the second layer of sealing material 4 is polyimide adhesive, the layer of magnesium alloy powder and the layer of polyimide adhesive are uniformly coated, and the magnesium alloy powder is located in the edge-sealing grooves 8

### Example 29

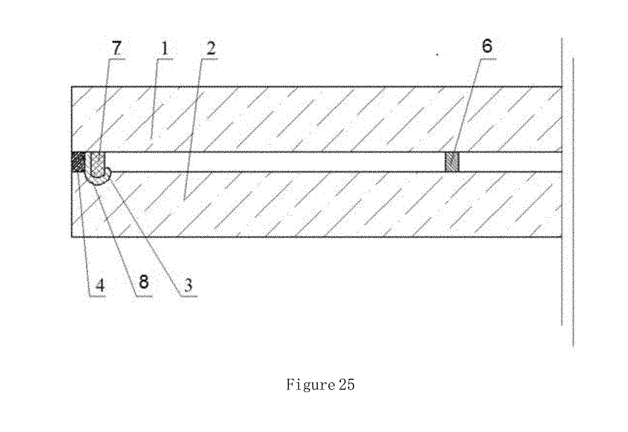

As shown in FIG. 25, the example is basically the same as that in example 12 except that the periphery of one or two pieces of glass is sealed by two layers of sealing material, the first layer of sealing material 3 is magnesium alloy powder, the second layer of sealing material 4 is low temperature glass solder, the layer of magnesium alloy powder 3 and the layer of low temperature glass solder 4 are uniformly coated using a coating machine, and the magnesium alloy powder 3 is located in the edge-sealing grooves 8

The vacuum glass of the present disclosure can be made of transparent and colorless glass, and used as common window glass, or can be insulation boards made of opaque or color glass, and used as thermal insulation wallboards. The vacuum glass and the vacuum glass insulation wallboards all belong to vacuum glass in the broad sense, and the structure and manufacturing method thereof can be achieved following the structure and manufacturing method in the present disclosure. The vacuum glass of embodiments of the present disclosure can be used as common window glass, can also be used as vacuum glass thermal insulation boards for preparation of thermal insulation wallboards.

Finally it shall be noted that, the above embodiments are only used to describe but not to limit the technical solutions of the present disclosure; and within the concept of the present disclosure, technical features of the above embodiments or different embodiments may also be combined with each other, the steps may be implemented in an arbitrary order, and many other variations in different aspects of the present disclosure described above are possible although, for purpose of simplicity, they are not provided in the details

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. Vacuum glass, comprising a piece of upper glass, a piece of lower glass, and a closed vacuum layer sandwiched between the upper class and the lower glass, wherein peripheries of the upper glass and the lower glass are in seal connection using two or more layers of sealing material, the upper glass and the lower glass are convex glass or flat glass, convex surfaces of the convex glass face outward, and supports are disposed between two pieces of flat glass.

2. The vacuum glass of claim 1, wherein the sealing material is two or three different kinds of sealing materials selected from glass solders, metal solders, and adhesives, or two or three sealing materials of the same kind.

3. The vacuum glass of claim 2, wherein the peripheries of the upper glass and/or the lower glass are provided with at least an edge-sealing groove.

4. The vacuum glass of claim 2, wherein a periphery of at least one glass of the upper glass and the lower glass is provided with an edge-sealing frame, and the edge-sealing frame is integrated with the upper glass and/or the lower glass.

5. The vacuum glass of claim 4, wherein the seal connection of the upper glass and the lower glass is achieved through the edge-sealing frame and the sealing material, and the edge-sealing frame of the upper glass and the edge-sealing frame of the lower glass are embedded with each other.

6. The vacuum glass of claim 2, wherein a periphery of at least one glass of the upper glass and the lower glass is provided with an edge-sealing frame, and a periphery of at least one glass is provided with an edge-sealing groove.

7. The vacuum glass of claim 6, wherein the seal connection of the upper glass and the lower glass is achieved through the embedment of the edge-sealing frame and the edge-sealing groove.

8. The vacuum glass of claim 3, wherein the sealing material is coated on one or two sides of the edge-sealing groove, or coated on a place corresponding to the edge-sealing groove, or placed in the edge-sealing groove.

9. The vacuum glass of claim 4, wherein the sealing material is coated on the edge-sealing frame, or coated between adjacent edge-sealing frames, or coated on a place corresponding to the edge-sealing frame.

10. The vacuum glass of claim 6, wherein the sealing material is coated on the edge-sealing frame, or coated between adjacent edge-sealing frames, or coated on a place corresponding to the edge-sealing frame; and the sealing material is coated on one or two sides of the edge-sealing groove, or coated on a place corresponding to the edge-sealing groove, or placed in the edge-sealing groove.

11. The vacuum glass of claim 1, wherein the supports are printed on the upper glass or the lower glass, and are dotted or cylindrical in shape.

12. The vacuum glass of claim 1, wherein the supports are printed on both the upper glass and the lower glass, and are strip or linear in shape.

13. A method for manufacturing the vacuum glass of any of claim 1, the method comprising the following steps:
1) cutting and acquiring two pieces of flat glass having dimensions corresponding to a desired shape and size of the vacuum glass, and grinding, chamfering, washing, and drying the two pieces of flat glass;
2) when manufacturing convex vacuum glass, performing hot bending on the two pieces of flat glass to form convex surfaces; when manufacturing flat vacuum glass, disposing the supports on at least one piece of flat glass, if disposing the supports on the two pieces of flat glass, staggering the supports on the two pieces of glass so as to ensure the alternate support of merged upper glass and lower glass; and when preparing tempered vacuum glass, tempering the two pieces of glass, respectively;
3) uniformly coating two or more layers of sealing material on peripheries of sealing surfaces of the lower glass or the two pieces of glass, the sealing material comprising a plurality of uniformly-distributed air extraction holes, merging the two pieces of glass and putting into a vacuum furnace; according to the properties of the sealing material and the glass and the requirements of manufacturing process, preheating or pre-evacuating the glass prior to or after the merging; and
4) vacuumizing the vacuum furnace to less than 0.1 Pa and heating the vacuum furnace to above a softening temperature of at least one sealing material, sealing the vacuum layer using the at least one sealing material by gravity or external pressure; continuing heating the vacuum furnace in vacuum or in air to reach a melting temperature of a second or third sealing material, holding the temperature, stopping heating, naturally cooling the furnace, whereby sealing the two pieces of glass by the sealing material, opening a furnace door of the vacuum furnace to obtain the vacuum glass.

14. The method of claim 13, wherein in 3), the sealing material is two or three different kinds of sealing materials selected from glass solders, metal solders, and adhesives, or two or three sealing materials of the same kind.

15. The method of claim 13, wherein in 4), following the seal achieved by at least one sealing material, removing the vacuum, heating the vacuum furnace in air to reach a melting temperature of a second or third sealing material, holding the temperature, stopping heating, naturally cooling the furnace, whereby sealing the two pieces of glass by the sealing material, opening a furnace door of the vacuum furnace to obtain the vacuum glass.

16. The method of claim 13, wherein in 2), the supports are made of low temperature glass or high polymers; the supports printed on the upper glass or the lower glass are dotted or cylindrical in shape, and the supports printed on both the upper glass and the lower glass are strip or linear in shape.

17. The method of claim 13, wherein the supports are printed prior to or after the tempering of the glass; when the supports are printed prior to the tempering of the glass, after being tempered, the supports are mechanically ground to remove and flatten tips of the supports, followed by rounding of top edges of the supports.

18. The method of claim 13, wherein in 1), prior to grinding, chamfering, washing, and drying, the method further comprises disposing one or more edge-sealing grooves on at least the upper or lower glass.

19. The method of claim 13, wherein in 2), the method further comprises disposing one or more edge-sealing frames on peripheries of sealing surfaces of at least one glass of the upper glass and/or the lower glass; when manufacturing convex vacuum glass, performing hot bending on the two pieces of flat glass to form convex surfaces; when manufacturing flat vacuum glass, disposing the supports on at least one piece of flat glass, if disposing the supports on the two pieces of flat glass, staggering the supports on the two pieces of glass so as to ensure the alternate support of merged upper glass and lower glass; and when preparing tempered vacuum glass, tempering the two pieces of glass, respectively.

20. The method of claim 13, wherein in 3), the method comprises coating two or more two or more layers of sealing material on peripheries of sealing surfaces of the lower glass or the two pieces of glass prepared in 2), and a second sealing layer is a metal sealing layer; if the upper glass and/or the lower glass comprises the edge-sealing frame, the sealing material is coated on the edge-sealing frame, or coated between adjacent edge-sealing frames, or coated on a place corresponding to the edge-sealing frame; if the upper glass and/or the lower glass comprises the edge-sealing groove, the sealing material is coated on one or two sides of the edge-sealing groove, or coated on a place corresponding to the edge-sealing groove, or placed in the edge-sealing groove; the sealing material comprises a plurality of uniformly-distributed air extraction holes, the two pieces of glass are merged and put into a vacuum furnace which is a continuous vacuum furnace or a batch-type vacuum furnace; according to the properties of the sealing material and the glass and the requirements of manufacturing process, preheating the glass prior to or after the merging.
